(19) United States
(12) Patent Application Publication
(10) Pub. No.: US 2018/0341374 A1
(43) Pub. Date: Nov. 29, 2018

(54) POPULATING A SHARE-TRAY WITH CONTENT ITEMS THAT ARE IDENTIFIED AS SALIENT TO A CONFERENCE SESSION

(71) Applicant: Microsoft Technology Licensing, LLC, Redmond, WA (US)

(72) Inventors: Jason Thomas FAULKNER, Seattle, WA (US); Kevin D. MORRISON, Arlington, MA (US); Ruchir ASTAVANS, Redmond, WA (US)

(21) Appl. No.: 15/607,208

(22) Filed: May 26, 2017

(51) Int. Cl. G06F 3/0482; G06F 11/34; G06F 11/30

(52) U.S. Cl. CPC G06F 3/0482; G06F 11/3024; G06F 11/3438

(57) ABSTRACT

A system populates a share-tray graphical user interface (GUI) with content items that are salient to a conference session. The system can analyze computing activities that a user has performed with respect to a set of content items to determine a subset of the content items. The system may analyze the computing activities with respect to share-tray population parameters to identify individual content items that have attributes which generally increase the probability of those content items being salient with respect to the conference session. Once the system has identified the subset of content items, user interface elements (UIEs) corresponding to individual salient content items can be displayed within the share-tray GUI to enable the user to select and share the salient content items during the conference session. The UIEs may be graphically arranged according to relative saliencies so that more salient content is more conspicuous to the user.

### BACKGROUND

At present, the use of conference (e.g., videoconference, teleconference, etc.) systems in personal and commercial settings has increased dramatically so that meetings between people in remote locations can be facilitated. In general, conference systems allow users, in two or more remote locations, to communicate interactively with each other via live, simultaneous two-way video streams, audio streams, or both. Some conference systems (e.g., CISCO WEBEX provided by CISCO SYSTEMS, Inc. of San Jose, Calif., GOTOMEETING provided by CITRIX SYSTEMS, INC. of Santa Clara, Calif., ZOOM provided by ZOOM VIDEO COMMUNICATIONS of San Jose, Calif., GOOGLE HANGOUTS by ALPHABET INC. of Mountain View, Calif., and SKYPE FOR BUSINESS provided by the MICROSOFT CORPORATION, of Redmond, Wash.) also allow users to share display screens that present, for example, images, text, video, applications, and any other content items that are rendered on the display screen(s) the user is sharing.

Conference systems enable a user to participate in a conference session (e.g., a meeting) via a remote device. A user may wish to share specific content items with other participants of the conference session. In these types of scenarios, if the user wants to share a particular content item, the user typically needs to manually search and/or navigate through a directory structure (e.g. a hierarchical tree structure of folders that contain files) of their remote device to find and open the particular content item. Then, the user typically situates the particular content item on a desired display area (e.g. a specific computer monitor) and, ultimately, shares the desired display area with the other participants of the conference session. Unfortunately, the other participants are often forced to wait while the user opens one folder after another to find the content items that are relevant to the present discussion. Worse yet, all too often, conference sessions involve discussions that transition between numerous content items where discussion downtime results from each transition.

### SUMMARY

The disclosed system addresses the problems described above. Specifically, the disclosed system may be configured to populate a share-tray graphical user interface (GUI) with content items that the system identifies as being salient to the conference session (e.g., content items that are related to the conference session such that user may elect to share them during the conference session). In some embodiments, the system can identify and/or analyze computing activities that a user has performed with respect to a set of content items (e.g., files, applications, etc.). Based on the computing activities, the system can determine a subset, of the set of content items identified and/or analyzed, that includes individual content items that have attributes which increase a probability of those content items being salient to the conference session. For example, the system may designate a particular file as being salient to the conference session based on attributes such as the particular file being heavily modified by the user in the period of time leading up to the conference session and/or a title of the particular file being similar to a title of the conference session. In some embodiments, the system can expose the share-tray GUI to a user when the user selects a share control user interface element (UIE) that is displayed in association with the conference session. In this way, the user's view of the conference session “stage view” is not unnecessarily obstructed by the share-tray GUI when the user is not about to share content. In one example, the stage view may include one or more video feeds corresponding to one or more participants of the conference session. Once exposed, the share-tray GUI may enable the user to seamlessly share content from the subset without having to manually navigate a directory structure of a computing device (e.g., open folder after folder to find the content item) and without interference to the user's visibility of at least a dominant portion of the “stage view” of the conference session.

Generally described, the techniques disclosed herein enable the system to receive activity log data that indicates computing activities that the user has performed with respect to a set of content items. The content items may include, for example, data files, computer applications (e.g., a computer-aided design (CAD) application that the user may use to show three-dimensional models to the other participants, a media player application that the user may use to show a video to the other participants, etc.), web browsers, user desktops, and/or any other type of content suitable for sharing during a conference session. The computing activities that the user may have performed with respect to a content item may include, for example, opening the content item just prior to commencement of the conference session, actively modifying the content item during a time period leading up to the conference session, and/or transmitting the content item (and/or iterations thereof) to another user that is invited to or registered with the conference session. The system may then analyze the activity log data based on share-tray population parameters that define attributes for defining the subset of the content items that are “salient” with respect to the conference session. That is, the share-tray population parameters define attributes that the system uses to identify and designate those individual content items that are to be displayed within the share-tray GUI. Then, when a user selects a UIE corresponding to a particular salient content item, the system may associate the particular salient content item with a media stream to enable client computing devices associated with the conference session to render aspects of the particular salient content item within a stage-view GUI of the conference session.

In various examples, the share-tray population parameters may cause the system to designate individual content items for inclusion in the subset based on a temporal proximity between a start time of the conference session and a time when a user performs a computing activity with an individual content item. For example, the system may include, in the subset, content items that have been modified by the user the night before a conference session while omitting other content items that have not been modified during the several weeks leading up to the conference session. In some implementations, the system may include in the subset individual content items that are being actively run by an operating system of a client computing device at a time when a user uses that client computing device to join the conference session. For example, the system may be configured to communicate with a system monitor program to identify computer applications and/or data files that are currently running on a computer. Then, based on the share-tray population parameters, the system may populate the share-tray GUI with the data files and/or computer applications that are currently running on the user's computer and/or satisfy one or more other attributes defined by the share-tray population parameters.

In various examples, the share-tray population parameters may cause the system to include individual content items in the subset based on collaborative computing activities that a user has performed with respect to the individual content items and another user that is registered for, participating in, and/or invited to the conference session. As used herein, the term “collaborative computing activity” may refer generally to any computing activity that facilitates (in any way) collaboration and/or communication between two or more users. Exemplary collaborative computing activities may include, but are not limited to, sending and/or receiving messages (e.g., emails, instant messages, etc.), uploading content to a share location (e.g., GOOGLE DRIVE, SHAREPOINT provided by the MICROSOFT CORPORATION, of Redmond, Wash., etc.), and/or sharing content during conference sessions. In some implementations, the system may include a content item in the subset based collaborative computing activities such as, for example, the user saving the content item to a share location that is also accessible by the other user, the user transmitting the content item to the other user (e.g., by email, instant message, etc.), the user sharing the content item with the other user during a previous conference session, and/or the user adding data content (e.g., an image, graphic, text, etc.) that was received from the other user to the content item.

In various examples, the share-tray population parameters may cause the system to graphically arrange, within the share-tray GUI, individual UIEs that correspond to individual ones of the salient content items based on relative saliencies of individual salient content items with respect to other salient content items. For example, within a share-tray GUI that is displayed in association with a conference session, UIEs corresponding to content items that are highly salient with respect to the conference session may be displayed more prominently than UIEs corresponding to content items that are minimally salient with respect to the conference session. In some examples, the individual UIEs may further be arranged according to categories of the salient content items. For example, the share-tray GUI may be separated into discrete sections wherein individual sections correspond to individual categories of content items. Exemplary categories of content items include, but are not limited to, discrete screens of the user's client computing device (e.g., monitor #1 and monitor #2), Productivity Suite (PS) Tabs (e.g., a Tab associated with a specific team in the MICROSOFT TEAMS Productivity Suite), discrete web browsers and/or discrete web browser tabs within one or more web browsers, data files (e.g., word processor files, spreadsheet files, slide deck files, media files such as images and/or videos, etc.), and/or computing applications.

The disclosed system is also or alternatively configured to enable a user to indicate one or more attributes such as content item categories (e.g., files having a particular file extension and/or format) and/or computing activities to intuitively search for and/or filter content items from within the share-tray GUI. That is, the share-tray GUI may provide a set of filter UIEs that are configured to enable the user to define attributes of content items. For example, the user may indicate one or more computing activities that have been performed with respect to the content items and/or a category to which the content items belong. Then, the system may filter through the set of content items and display to the user a subset of the content items that correspond to the user defined attributes (e.g., a subset that is determined to be salient based on the user defined attributes). For example, during a conference session a user may wish to share a particular content item that the user remembers having sent to another user (e.g., “Bob”) within the last two weeks. Accordingly, the set of filter UIEs may enable the user to input these attributes to cause the system to display, within the share-tray GUI, only those content items that the user has sent to “Bob” within the last two weeks via one or more communication forums (e.g., email accounts, instant messaging forums, etc.) that the system is configured to access data from.

In various examples, the system may be configured to prompt the user to indicate one or more content items that are to be included and/or excluded from the share-tray GUI during the conference session. The user may be prompted before the conference session and/or during the conference session. For example, the system may be configured to generate a pop up style notification on the user's client computing device at a predetermined threshold of time prior to commencement of the conference session (e.g., fifteen minutes before the conference session, five minutes before the conference session, etc.). Then, based on user provided feedback, the system may specifically tailor the subset to be displayed within the share-tray GUI. For example, just prior to the conference session, the system may expose a list of content items that the system has determined to be potentially salient to the conference session and may prompt the user to indicate which content items from the list should be included in the subset. In some implementations, the system may also enable the user to specifically add content items to the subset that are not included within the list of content items that the system is determined to be essentially salient to the conference session.

Consequently, the system described herein provides a tool that enables a user to efficiently and effectively share content items during a conference session without having to manually navigate through a directory structure of a computing device while other participants wait for the user to locate the content the user wishes to share. The system described herein further enables the user to prepare for the conference session by customizing which content items to display within a share-tray GUI so that the user can quickly locate and share content items that are salient to the conference session without having to overlook and/or scroll through other content items that are irrelevant to the conference session. For example, in the event that a user knows in advance that he or she is responsible for sharing two (and only two) content items during a conference session, then the user can specifically customize a subset of content items to include only these two content items. Accordingly, during the conference session the share-tray will include no more and no less than those content items that the user intends to share during the conference session.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWING

The detailed description is described with reference to the accompanying figures. In the figures, the left-most digit(s) of a reference number identifies the figure in which the reference number first appears. The same reference numbers in different figures indicate similar or identical items.

FIG. 1 is a diagram illustrating an example environment in which a system can populate a share-tray graphical user interface with content items that the system identifies as being salient to a conference session.

FIG. 2 is a diagram illustrating example components of an example device configured to populate a share-tray graphical user interface with content items that the system identifies as being salient to a conference session.

FIG. 3A illustrates an example graphical user interface configured to display user interface elements over a persistent view of live content of the conference session.

FIG. 3B illustrates aspects of an example share-tray graphical user interface that can be displayed over the persistent view of FIG. 3A.

FIG. 3C illustrates aspects of an example share-tray graphical user interface with a selected content type region in an expanded state.

FIG. 3D illustrates aspects of an example share-tray graphical user interface in which salient content item user interface elements from a variety of categories are graphically arranged according to their relative saliencies with respect to one another.

FIG. 3E illustrates aspects of an example share-tray graphical user interface in an alternate graphical arrangement in which the salient content item user interface elements are separated according to types and/or categories and are further graphically arranged according to their relative saliencies with respect to one another.

FIG. 3F illustrates a version of an example share-tray graphical user interface that enables a user to define one or more share-tray population parameters.

FIG. 3G illustrates aspects of an example share-tray graphical user interface in an arrangement in which one or more groupings of salient content items are shown in a list arrangement having multiple columns of salient content item user interface elements.

FIG. 4A illustrates aspects of an example “Partial-Stage” view graphical user interface that can be displayed on a client computing device in response to a user a content item.

FIG. 4B illustrates aspects of an example “Full-Stage” view graphical user interface that can be displayed on a client computing device in response to a user a content item.

FIG. 5 illustrates aspects of an example share-tray population graphical user interface that can be displayed on a client device to enable a user to manually define one or more salient content items to be included within the share-tray graphical user interface during the conference session.

FIG. 6 is a diagram of an example flowchart that illustrates operations directed to identifying a salient subset of content items to populate into a share-tray graphical user interface in association with a conference session.

FIG. 7 is a diagram of an example flowchart that illustrates operations directed to arranging salient content item UIEs within a share-tray graphical user interface based on their relative saliencies.

### DETAILED DESCRIPTION

Examples described herein provide a system that populates a share-tray graphical user interface with content items that are identified as being salient (e.g., relevant and/or related) to a conference session. The system can analyze computing activities that a user has performed with respect to a set of content items (e.g., files, applications etc.). Then, based on the computing activities, the system can identify a subset of the content items that are determined to be “salient” with respect to the conference session (also referred to herein as a “salient subset”). For example, the system may analyze the computing activities with respect to share-tray population parameters to identify individual content items that have attributes which generally increase the probability of those content items being salient with respect to the conference session. Stated alternatively, the system identified attributes may indicate which content items are likely related to the conference session such that a user may elect to share them during the conference session. Once the system has identified this subset of content items, user interface elements corresponding to individual salient content items can be displayed within the share-tray graphical user interface to enable the user to select and ultimately to share the salient content items during the conference session. Consequently, the system described herein provides a tool that enables a user to efficiently and effectively share content items during a conference session without having to manually navigate through a directory structure of a computing device while other participants wait for the user to locate the content the user wishes to share.

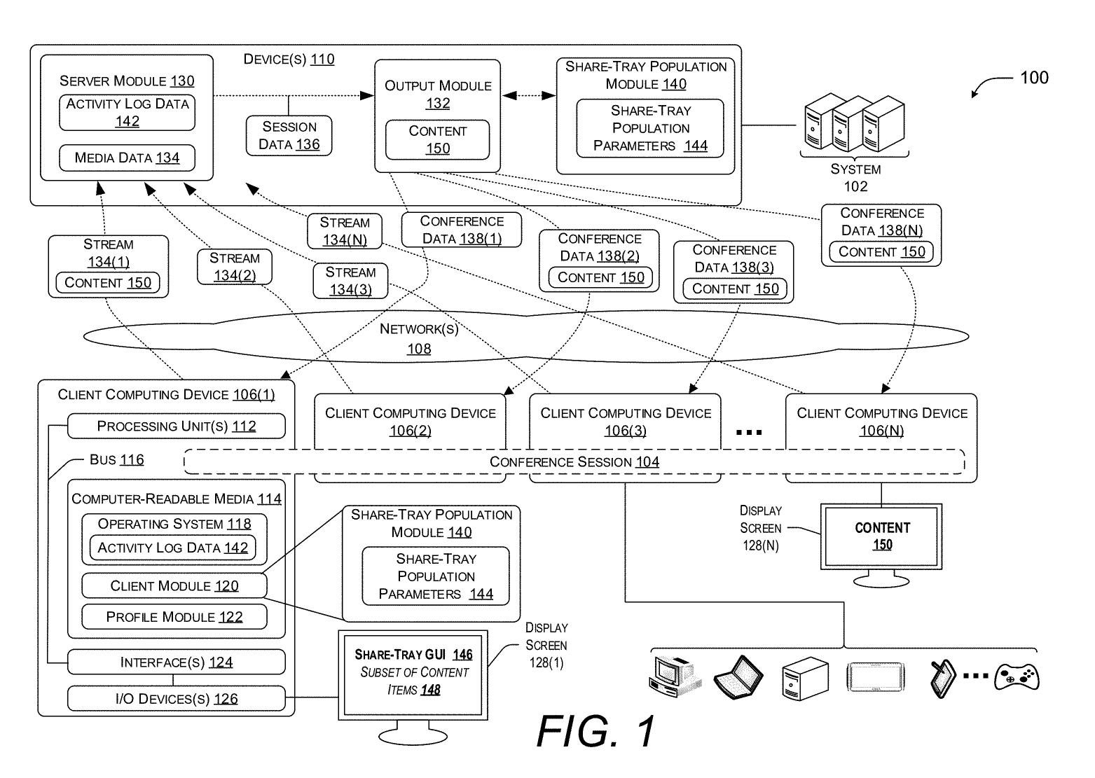

Various examples, implementations, scenarios, and aspects are described below with reference to FIGS. 1 through 7.

FIG. 1 is a diagram illustrating an example environment 100 in which a system 102 can operate to populate a share-tray graphical user interface (GUI) with content items that the system identifies as being salient to the conference session. Content items may be identified by the system 102 as being salient to the conference session 104 based upon predefined attributes that are defined within share-tray population parameters as described herein. In this example, the conference session 104 is implemented between a number of client computing devices 106(1) through 106(N) (where N is a positive integer number having a value of two or greater). The client computing devices 106(1) through 106(N) enable users to participate in the conference session 104. In this example, the conference session 104 is hosted, over one or more network(s) 108, by the system 102. That is, the system 102 can provide a service that enables users of the client computing devices 106(1) through 106(N) to participate in the conference session 104 (e.g., via a live viewing and/or a recorded viewing). Consequently, a “participant” to the conference session 104 can comprise a user and/or a client computing device (e.g., multiple users may be in a conference room participating in a conference session via the use of a single client computing device), each of which can communicate with other participants. As an alternative, the conference session 104 can be hosted by one of the client computing devices 106(1) through 106(N) utilizing peer-to-peer technologies. The system 102 can also host chat conversations and other team collaboration functionality (e.g., as part of an application suite). In one example, a chat conversation can be conducted in accordance with the conference session 104.

In examples described herein, client computing devices 106(1) through 106(N) participating in the conference session 104 are configured to receive and render for display, on a user interface of a display screen, conference data. The conference data can comprise a collection of various instances, or streams, of live content. For example, an individual stream of live content can comprise media data associated with a video feed (e.g., audio and visual data that capture the appearance and speech of a user participating in the conference session). Another example of an individual stream of live content can comprise media data that includes an avatar of a user participating in the conference session along with audio data that captures the speech of the user. Yet another example of an individual stream of live content can comprise media data that includes a file displayed on a display screen along with audio data that captures the speech of a user. Accordingly, the various streams of live content within the conference data enable a remote meeting to be facilitated between a group of people and the sharing of content within the group of people.

The system 102 includes device(s) 110. The device(s) 110 and/or other components of the system 102 can include distributed computing resources that communicate with one another and/or with the client computing devices 106(1) through 106(N) via the one or more network(s) 108. In some examples, the system 102 may be an independent system that is tasked with managing aspects of one or more conference sessions such as conference session 104. As an example, the system 102 may be managed by entities such as SLACK, WEBEX, GOTOMEETING, GOOGLE HANGOUTS, etc.

Network(s) 108 may include, for example, public networks such as the Internet, private networks such as an institutional and/or personal intranet, or some combination of private and public networks. Network(s) 108 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 108 may utilize communications protocols, including packet-based and/or datagram-based protocols such as Internet protocol (“IP”), transmission control protocol (“TCP”), user datagram protocol (“UDP”), or other types of protocols. Moreover, network(s) 108 may also include a number of devices that facilitate network communications and/or form a hardware basis for the networks, such as switches, routers, gateways, access points, firewalls, base stations, repeaters, backbone devices, and the like.

In some examples, network(s) 108 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.11 standards (e.g., 802.11 g, 802.11 n, and so forth), and other standards.

In various examples, device(s) 110 may include one or more computing devices that operate in a cluster or other grouped configuration to share resources, balance load, increase performance, provide fail-over support or redundancy, or for other purposes. For instance, device(s) 110 may belong to a variety of classes of devices such as traditional server-type devices, desktop computer-type devices, and/or mobile-type devices. Thus, although illustrated as a single type of device—a server-type device—device(s) 110 may include a diverse variety of device types and are not limited to a particular type of device. Device(s) 110 may represent, but are not limited to, server computers, desktop computers, web-server computers, personal computers, mobile computers, laptop computers, tablet computers, or any other sort of computing device.

A client computing device (e.g., one of client computing device(s) 106(1) through 106(N)) may belong to a variety of classes of devices, which may be the same as, or different from, device(s) 110, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant (“PDA”), a mobile phone/tablet hybrid, a laptop computer, a telecommunication device, a computer navigation type client computing device such as a satellite-based navigation system including a global positioning system (“GPS”) device, a wearable device, a virtual reality (“VR”) device, an augmented reality (AR) device, an implanted computing device, an automotive computer, a network-enabled television, a thin client, a terminal, an Internet of Things (“IoT”) device, a work station, a media player, a personal video recorders (“PVR”), a set-top box, a camera, an integrated component (e.g., a peripheral device) for inclusion in a computing device, an appliance, or any other sort of computing device. Moreover, the client computing device may include a combination of the earlier listed examples of the client computing device such as, for example, desktop computer-type devices or a mobile-type device in combination with a wearable device, etc.

Client computing device(s) 106(1) through 106(N) of the various classes and device types can represent any type of computing device having one or more processing unit(s) 112 operably connected to computer-readable media 114 such as via a bus 116, which in some instances can include one or more of a system bus, a data bus, an address bus, a PCI bus, a Mini-PCI bus, and any variety of local, peripheral, and/or independent buses.

Executable instructions stored on computer-readable media 114 may include, for example, an operating system 118, a client module 120, a profile module 122, and other modules, programs, or applications that are loadable and executable by processing units(s) 112.

Client computing device(s) 106(1) through 106(N) may also include one or more interface(s) 124 to enable communications between client computing device(s) 106(1) through 106(N) and other networked devices, such as device(s) 110, over network(s) 108. Such network interface(s) 124 may include one or more network interface controllers (NICs) or other types of transceiver devices to send and receive communications and/or data over a network. Moreover, client computing device(s) 106(1) through 106(N) can include input/output (“I/O”) interfaces 126 that enable communications with input/output devices such as user input devices including peripheral input devices (e.g., a game controller, a keyboard, a mouse, a pen, a voice input device such as a microphone, a touch input device, a gestural input device, and the like) and/or output devices including peripheral output devices (e.g., a display, a printer, audio speakers, a haptic output device, and the like). FIG. 1 illustrates that client computing device 106(1) is in some way connected to a display device (e.g., a display screen 128(1)), which can display a share-tray GUI according to the techniques described herein.

In the example environment 100 of FIG. 1, client computing devices 106(1) through 106(N) may use their respective client modules 120 to connect with one another and/or other external device(s) in order to participate in the conference session 104, or in order to contribute activity to a collaboration environment. For instance, a first user may utilize a client computing device 106(1) to communicate with a second user of another client computing device 1062. When executing client modules 120, the users may share data, which may cause the client computing device 106(1) to connect to the system 102 and/or the other client computing devices 1062 through 106(N) over the network(s) 108.

The client computing device(s) 106(1) through 106(N) may use their respective profile module 122 to generate participant profiles, and provide the participant profiles to other client computing devices and/or to the device(s) 110 of the system 102. A participant profile may include one or more of an identity of a user or a group of users (e.g., a name, a unique identifier (“ID”), etc.), user data such as personal data, machine data such as location (e.g., an IP address, a room in a building, etc.) and technical capabilities, etc. Participant profiles may be utilized to register participants for conference sessions.

As shown in FIG. 1, the device(s) 110 of the system 102 includes a server module 130 and an output module 132. In this example, the server module 130 is configured to receive, from individual client computing devices such as client computing devices 106(1) through 106(N), media streams 134(1) through 134(N). As described above, media streams can comprise a video feed (e.g., audio and visual data associated with a user), audio data which is to be output with a presentation of an avatar of a user (e.g., an audio only experience in which video data of the user is not transmitted), text data (e.g., text messages), file data and/or screen sharing data (e.g., a document, a slide deck, an image, a video displayed on a display screen, etc.), and so forth. Thus, the server module 130 is configured to receive a collection of various media streams 134(1) through 134(N) during a live viewing of the conferenced session 104 (the collection being referred to herein as media data 134). In some scenarios, not all the client computing devices that participate in the conference session 104 provide a media stream. For example, a client computing device may only be a consuming, or a “listening”, device such that it only receives content associated with the conference session 104 but does not provide any content to the conference session 104.

In various examples, the server module 130 can select aspects of the media data 134 that are to be shared with individual ones of the participating client computing devices 106(1) through 106(N). Consequently, the server module 130 may be configured to generate session data 136 based on the streams 134 and/or pass the session data 136 to the output module 132. Then, the output module 132 may communicate conference data 138 to the client computing devices (e.g., client computing devices 106(1) through 106(3) participating in a live viewing of the conference session). As shown, the output module 132 transmits conference data 138(1) to client computing device 106(1), and transmits conference data 138(2) to client computing device 106(2), and transmits conference data 138(3) to client computing device 106(3), etc. The conference data transmitted to the client computing devices can be the same or can be different (e.g., positioning of streams of content within a user interface may vary from one device to the next).

In various implementations, the device(s) 110 and/or the client module can include a share-tray population module 140, and in various examples, the share-tray population module 140 is configured to analyze activity log data 142 based on share-tray population parameters 144 to identify a subset of content items to include within a share-tray GUI. For instance, as illustrated, a share-tray GUI is being displayed at the client computing device 106(1) and, in particular, by the display screen 128(1). As used herein, the term “activity log data” may refer generally to any log files that are generated by one or more of the client computing devices 106(1) through 106(N) and/or the devices 110 and that are stored as a persistent record of one or more computing activities that a user has performed with respect to one or more individual content items. In some implementations, the activity log data 142 may be generated by and stored in association with the operating system 118. Alternatively or additionally, the activity log data may be generated by and stored in association with the server module 130.

In various examples, the share-tray population module 140 is configured to examine the activity log data against the share-tray population parameters 144 to selectively populate a share-tray GUI 146 with a subset of content items 148. Example attributes that may cause the system to include a particular content item within the subset can include: a user accessing the content item within a particular period of time leading up to the conference session 104, the user sending the content item to another participant of the conference session 104, the content item having a similar title to a title of the conference session 104, a keyword search of the content item revealing numerous similar terms to a keyword search of a calendar object (and/or attachments thereof) corresponding to the conference session 104, the content item being actively run by the operating system 118 at the client computing device 106(1) when a user uses the client module 120 to join the conference session 104, the content item being stored to a share location that is accessible by one or more other participants of the conference session 104, or any other attribute determined to be related to a probability that a user will elect to share a content item during the conference session 104.

As illustrated, a client computing device such as client computing device 106(1) can render the subset of salient content items 148 within the share-tray GUI 146 to enable the user to select a particular content item 150 to share in association with the conference session 104. For instance, a user selection of the content 150 may cause the client computing device 106(1) to associate aspects of the content 150 with stream 134(1). Then, these aspects of the content 150 may be added by the server module 130 and/or output module 132 to the conference data 138 that is being transmitted to the individual client computing devices 106(2) through 106(N). For instance, as illustrated, the content 150 has been added to the conference data 138(N) that is being transmitted to the client computing device 106(N) to cause a display screen 128(N) to render aspects of the content 150, e.g. within a stage view of the conference session 104.

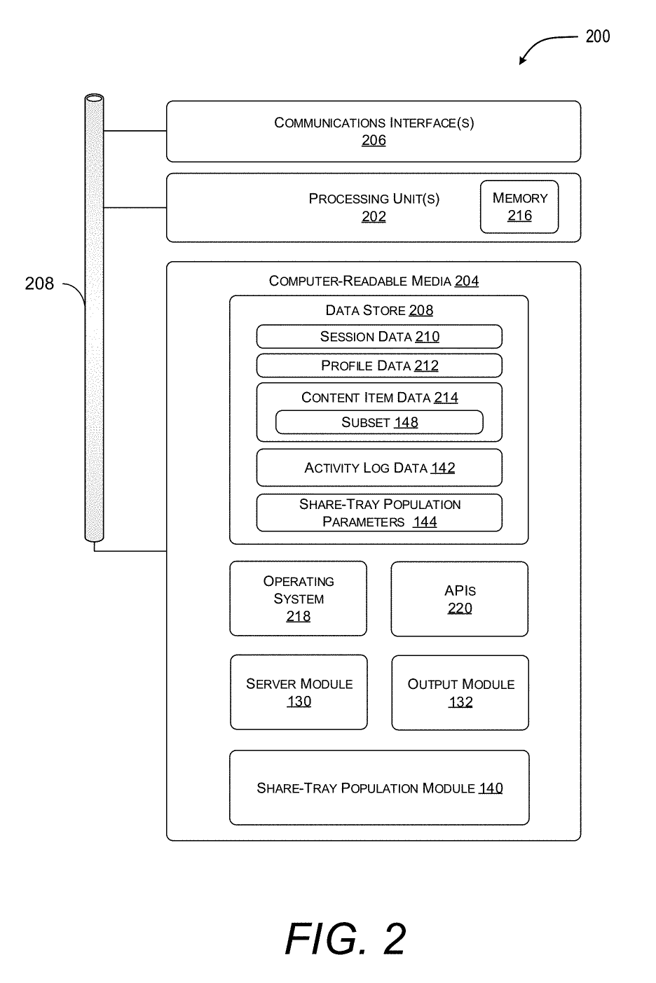

FIG. 2 illustrates a diagram that shows example components of an example device 200 configured populate a share-tray graphical user interface (GUI) with content items that the system identifies as being salient to the conference session based on share-tray population parameters. The device 200 may represent one of device(s) 110. Additionally or alternatively, the device 200 may represent one of the client computing devices 106. As illustrated, the device 200 includes one or more processing unit(s) 202, computer-readable media 204, and communication interface(s) 206. The components of the device 200 are operatively connected, for example, via a bus, which may include one or more of a system bus, a data bus, an address bus, a PCI bus, a Mini-PCI bus, and any variety of local, peripheral, and/or independent buses.

As utilized herein, processing unit(s), such as the processing unit(s) 202 and/or processing unit(s) 112, may represent, for example, a CPU-type processing unit, a GPU-type processing unit, a field-programmable gate array (“FPGA”), another class of digital signal processor (“DSP”), or other hardware logic components that may, in some instances, be driven by a CPU. For example, and without limitation, illustrative types of hardware logic components that may be utilized include Application-Specific Integrated Circuits (“ASICs”), Application-Specific Standard Products (“AS SPs”), System-on-a-Chip Systems (“SOCs”), Complex Programmable Logic Devices (“CPLDs”), etc.

As utilized herein, computer-readable media, such as computer-readable media 204 and/or computer-readable media 114, may store instructions executable by the processing unit(s). The computer-readable media may also store instructions executable by external processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random-access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interface(s) 206 may represent, for example, network interface controllers (“NICs”) or other types of transceiver devices to send and receive communications over a network.

In the illustrated example, computer-readable media 204 includes a data store 208. In some examples, data store 208 includes data storage such as a database, data warehouse, or other type of structured or unstructured data storage. In some examples, data store 208 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 208 may store data for the operations of processes, applications, components, and/or modules stored in computer-readable media 204 and/or executed by processing unit(s) 202 and/or accelerator(s). For instance, in some examples, data store 208 may store session data 210 (e.g., session data 136), profile data 212 (e.g., associated with a participant profile), and/or other data. The session data 210 can include a total number of participants (e.g., users and/or client computing devices) in a conference session, activity that occurs in the conference session, an list of invitees to the conference session, and/or other data related to when and how the conference session is conducted or hosted. The data store 208 can also include content item data 214 identifying a set of content items associated with a user as well as various attributes of those content items such as, for example, data file types of the content items, application types of the content items, and/or any other suitable attribute. The data store can also include activity log data 142 identifying one or more computing activities that a user has performed with respect to one or more content items as identified in the content item data 214. The activity log data 142 may indicate, for example, a date that a particular content item was last modified by the user, a date that a particular content item was last accessed by the user, to whom the user has transmitted the particular content item, from whom the user has received the particular content item, and/or any other suitable computing activity that may be determined to have some bearing on how probable it is that a user may elect to share the content item during the conference session 104. As described above, the share-tray population module 140 may be configured to analyze a set of content items (e.g., as identified in the content item data 214) based on the activity log data 142 and/or the share-tray population parameters 144 to identify the subset of content items 148.

Alternately, some or all of the above-referenced data can be stored on separate memories 216 on board one or more processing unit(s) 202 such as a memory on board a CPU-type processor, a GPU-type processor, an FPGA-type accelerator, a DSP-type accelerator, and/or another accelerator. In this example, the computer-readable media 204 also includes operating system 218 and application programming interface(s) 220 configured to expose the functionality and the data of the device 200 to other devices. Additionally, the computer-readable media 204 includes one or more modules such as the server module 130, the output module 132, and the share-tray population module 140, although the number of illustrated modules is just an example, and the number may vary higher or lower. That is, functionality described herein in association with the illustrated modules may be performed by a fewer number of modules or a larger number of modules on one device or spread across multiple devices.

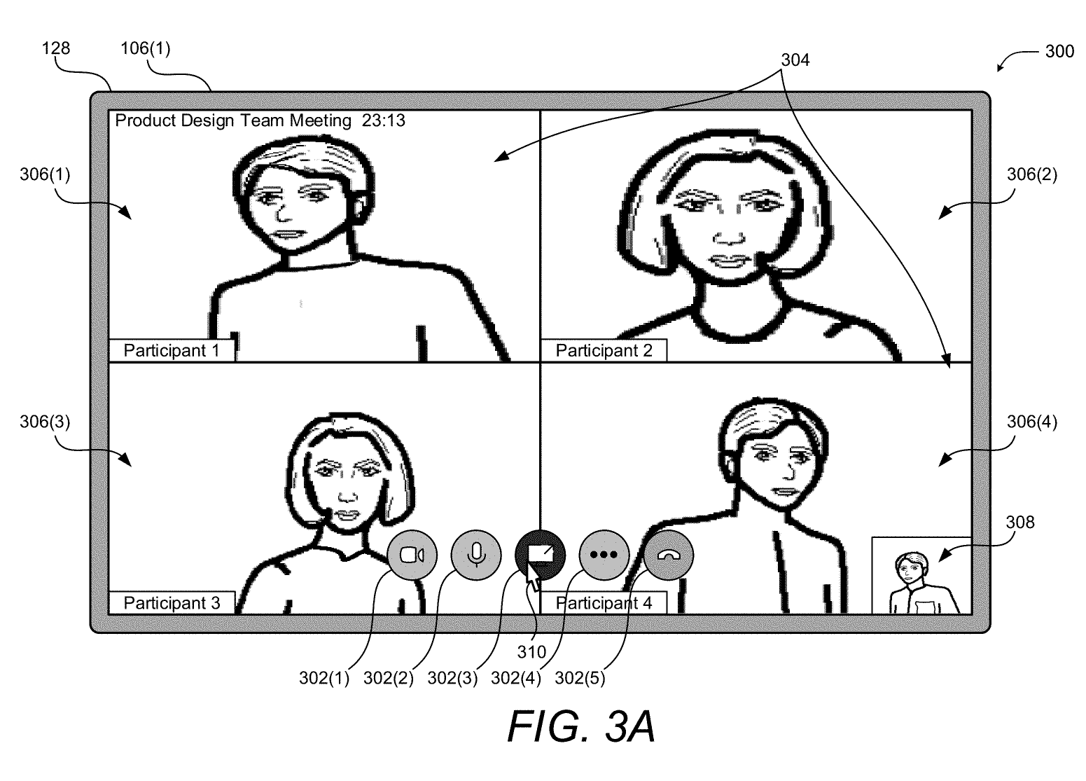

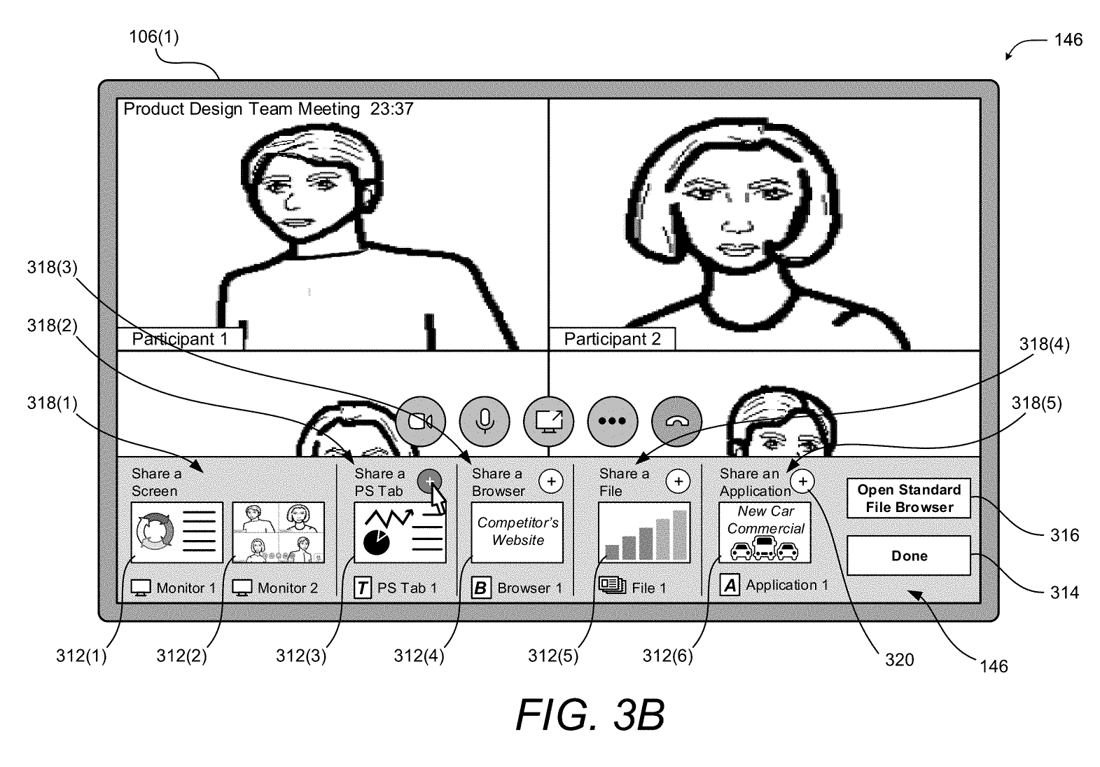

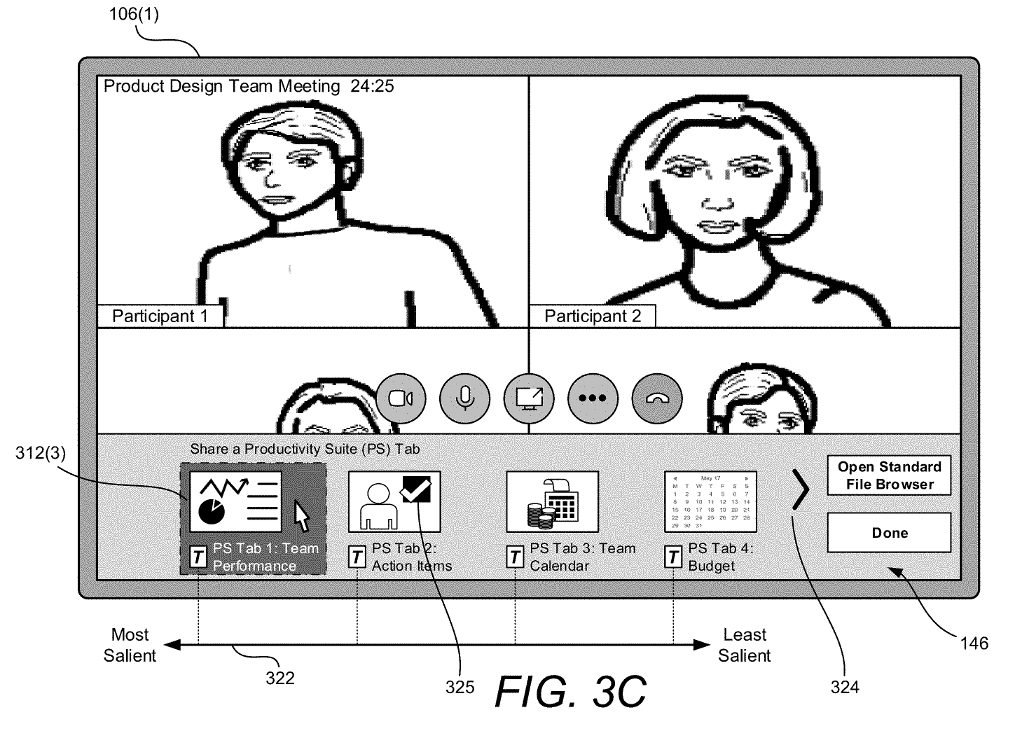

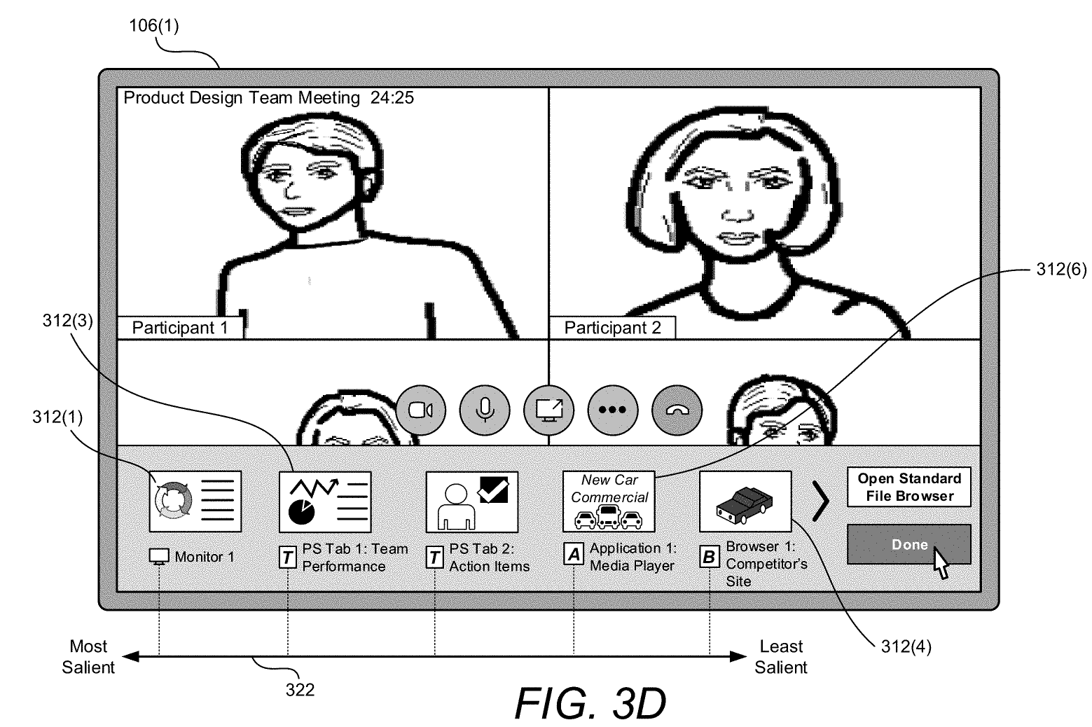

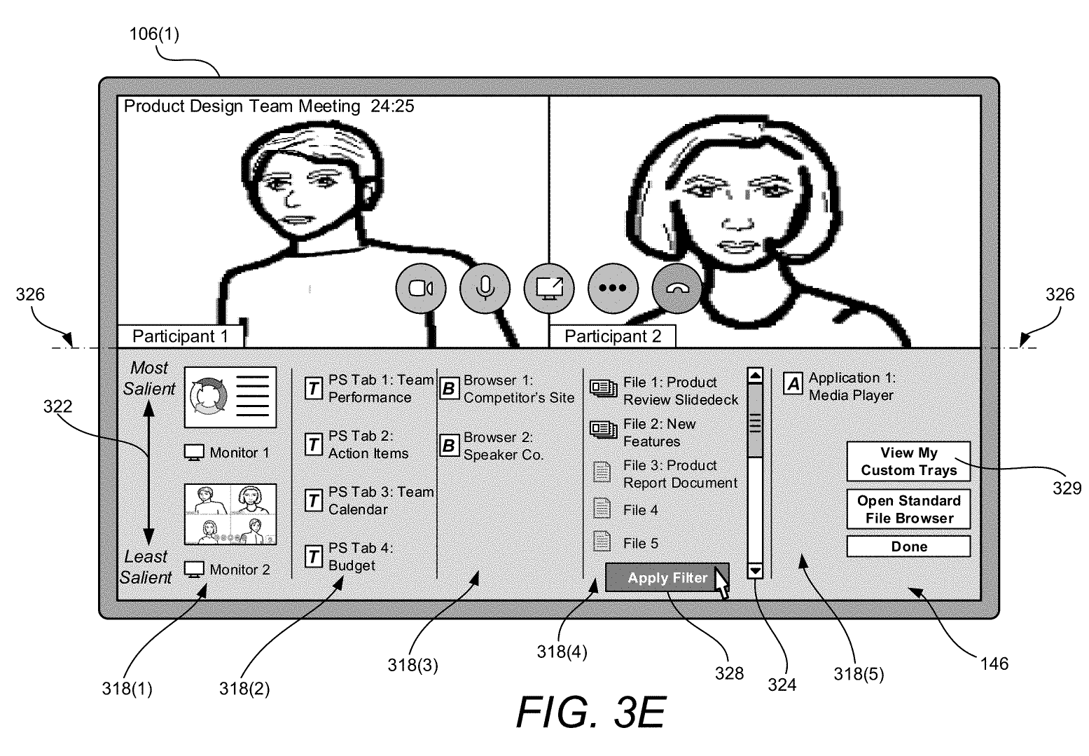

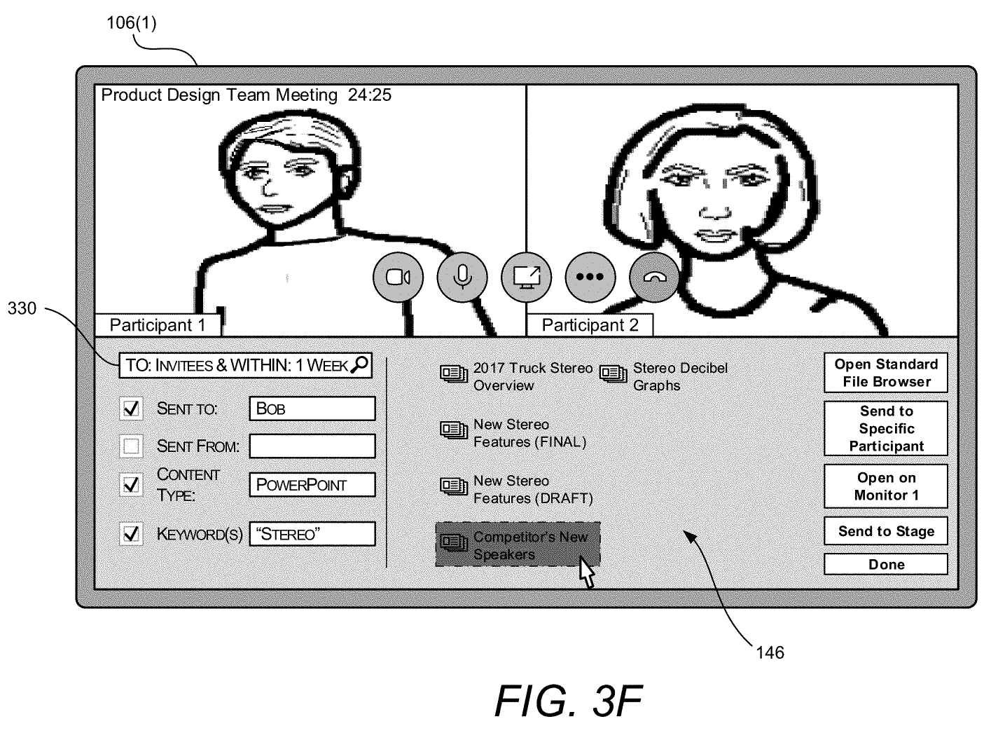

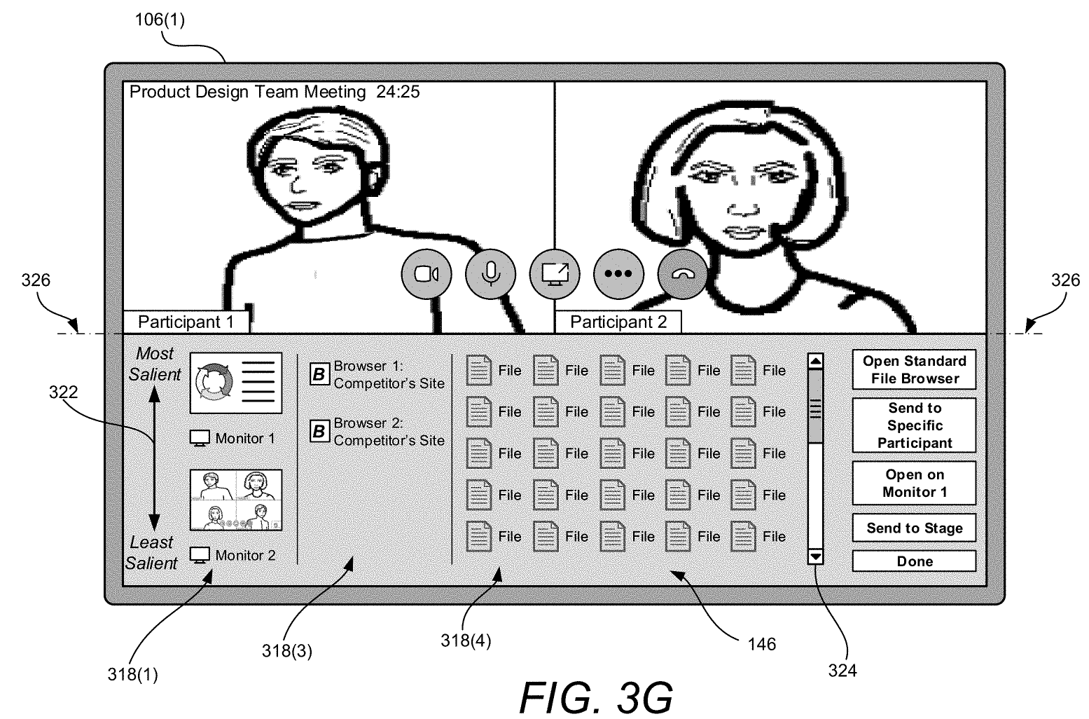

FIG. 3A illustrates an example graphical user interface (GUI) 300 configured to display user interface elements (UIEs) 302 in association with live content of the conference session 104. As illustrated, the GUI 300 includes five UIEs 302 labeled 302(1) through 302(5). More specifically, the GUI 300 may include a video on/off UIE 302(1) to enable the user to control whether video is streamed from the user's client computing device in association with the conference session 104, an audio on/off UIE 302(2) to enable the user to control whether audio is streamed from the user's client computing device in association with the conference session 104, a share-control UIE 302(3) to enable the user to selectively expose and/or hide a share-tray GUI 146 as described in detail elsewhere herein, an additional control UIE 302(4) to enable the user to selectively expose and/or hide additional controls in association with the conference session 104, and a “hang up” UIE 302(5) to enable the user to exit the conference session 104.

In some embodiments, the UIEs 302 may be displayed over a persistent view 304 of the conference session 104. The persistent view 304 may be associated with a “stage” of the conference session 104 that is occupied by the most relevant speakers and/or content of the conference session 104 at any particular time. For example, the system 102 may identify which participant and/or participants are the most dominant during the conference session 104 (or portions thereof) to determine which participants to display within the persistent view 304.

When multiple participants are displayed within the persistent view 304, the system 102 may identify which portion of the display 128 each participant is to be displayed within. For example, in the illustrated scenario, the persistent view 304 includes four distinct regions labeled 306(1) through 306(4) that each correspond to a particular participant of the conference session 104. In this particular example, a first region 306(1) corresponds to a first participant “Participant 1” that is a most dominant participant, a second region 306(2) corresponds to a second participant “Participant 2” that is a second-most dominant participant, etc.

In various implementations, the relative dominance of one or more participants with respect to other participants may be determined automatically by the system 102 based on various factors such as, for example, an amount of audio content streaming in association with that participant's client device (e.g., if a particular user is speaking the most during the conference session 104 the system 102 may determine that participant to be the most dominant participant), whether a particular participant is currently sharing content such as a display screen or a video file in association with the conference session 104, or any other factor suitable for determining which stream(s) 134 are should be rendered within the persistent view 304 and/or particular regions 306 thereof. As further illustrated, the GUI 300 may include a mirror-view region 308 that displays to the user on the user's own device how the user appears to other participants of the conference session 104 within a corresponding region 306 on the other participants' client computing devices.

In the scenario illustrated in FIG. 3A, the user is shown to be using a cursor 310 to select the share-control UIE 302(3) and, ultimately, to cause a share-tray GUI to be exposed as illustrated in FIG. 3B.

Turning now to FIG. 3B, aspects are illustrated of an example share-tray GUI 146 that can be displayed over the persistent view 304 of FIG. 3A in response to the user selection of the share-control UIE 302(3). As described above, the share-tray GUI 146 is configured to display a plurality of salient content item UIEs 312 to enable the user to share various content items that the system 102 has identified as salient with respect to the conference session 104. For instance, the system 102 may analyze the content item data 214 based on one or both of the activity log data 142 and the share-tray population parameters 144 to identify the subset 148 of content items. Then, the system 102 may display the salient content item UIEs 312 within the share-tray GUI 146 to enable the user to quickly and seamlessly share content (e.g., either from the user's client computing device and/or from a cloud-based computing account) with the other participants of the conference session 104. As further illustrated, the share-tray GUI 146 may also include a “DONE” UIE 314 that enables the user to close the share-tray GUI 146. That is, by selecting the “DONE” UIE 314 the user may cause the share-tray GUI 146 to disappear and the portion of the persistent view 304 that was previously blocked by the share-tray GUI 146 to be re-exposed.

In some implementations, the share-tray GUI 146 may further include an “Open Standard File Browser” UIE 316 to enable the user to search through a directory structure (e.g., a folder architecture associated with the user's client computing device and/or a cloud-based storage service) to locate content items to share during the conference session 104 and/or to include within the share-tray GUI 146. For instance, in the event that none of the salient content item UIEs correspond to a particular content item the user wishes to share, the user may select the “Open Standard File Browser” UIE 316 to cause a standard file browser to be opened in association with the conference session 104 to enable the user to locate any content that can be discovered through the standard file browser regardless of whether that content has been identified by the system 102 as salient with respect to the conference session 104.

In the example of FIG. 3B, the share-tray GUI 146 is configured to separate the salient content item UIEs 312 according to types and/or categories. For instance, as illustrated the share-tray GUI 146 includes five separate content type regions labeled 318(1) through 318(5).

This illustrated example includes a salient screen region 318(1) that includes a “Monitor 1” UIE 312(1) to enable the user to share content that is currently being displayed on a first monitor of the user's client computing device 106, and a “Monitor 2” UIE 312(2) to enable the user to share content that is currently being displayed on a second monitor of the user's client computing device 106. Accordingly, leading up to a point in time at which the user will begin to share content in association with the conference session 104, the user may situate the content on a particular monitor of the user's client computing device 106. For example, the user may situate a PowerPoint presentation on the user's first monitor and further situate the persistent view 304 on the user's second monitor. Then, at whatever time he or she wishes to share the PowerPoint presentation, the user may select the “Monitor 1” UIE 312(1) to send the PowerPoint presentation and, more particularly, the portion of the PowerPoint presentation being displayed on the user's first monitor to the “stage” of the conference session 104 (i.e., the user may cause the presentation to be displayed within the persistent view 304 at the computing devices of the other participants).

The illustrated example also includes a Productivity Suite (PS) Tab region 318(2) that includes a “Tab 1” UIE 312(3) to enable the user to share content that has been “tabbed” in association with a Productivity Suite. Exemplary Productivity Suites include, for example, GOOGLE G-SUITE, ZOHO OFFICE SUITE, or MICROSOFT OFFICE 365. An exemplary form of “tabbing” content in association with a Productivity Suite may include, for example, deploying the MICROSOFT TEAMS workspace to associated content (e.g., a data file, a webpage, an application, etc.) with a “Channel” that has been developed by a team to facilitate a focused conversation about a specific topic.

The illustrated example also includes a browser region 318(3) that includes a “Browser 1” UIE 312(4) to enable the user to share content associated with a particular web browsers and/or tabs thereof. For instance, the system 102 may analyze portions of the activity log data 142 corresponding to a user's browsing history on one or more web browsers to identify content that is likely to be salient to the conference session 104. As a more specific, but nonlimiting example, in preparation for a particular conference session associated with a “Product Design Team Meeting,” a user may frequently access a website of a main competitor to check-in on how their product design stacks up against the competition. The system 102 may identify the competitor's website as being potentially salient to the conference session 104 based on a variety of factors such as, for example, a keyword search of the competitor's website versus one or more keyword searches of other content known to be associated with (or salient with respect to) the conference session 104, a determination that the user frequently accesses the competitor's website while working on a data file that is known to be associated with (or salient with respect to) the conference session 104, or any other factor suitable for measuring the a websites saliency with respect to the conference session 104.

The illustrated example also includes a data file region 318(4) that includes a “File 1” UIE 312(5) to enable the user to share a particular data file. Accordingly, by selecting the “File 1” UIE 312(5) the user may cause the user's client computing device to send aspects associated with a particular file to the “stage” of the conference session 104. Additionally or alternatively, selecting the “File 1” UIE 312(5) may cause the particular file itself (e.g., access to and/or a copy thereof) to be sent to the other participants' client computing devices.

The illustrated example also includes an application region 318(5) that includes an “Application 1” UIE 312(6) to enable the user to share a particular application. Accordingly, by selecting the “Application 1” UIE 312(6) the user may cause the user's client computing device to send to stage whatever activity may be occurring with respect to a particular application. For example, the “Application 1” UIE 312(6) may correspond to a media player application such that selection of the UIE 312(6) may cause whatever content that is being currently displayed (either visually and/or audibly) by the media player application at the user's client computing device to be sent to stage and, therefore, displayed and/or audibly played at the client computing devices associated with the other participants of the conference session 104.

In some embodiments, the salient content item UIEs 312 may be configured to “preview” content to the user to enable the user to quickly identify which content items the user wishes to share. For example, as illustrated, individual ones of the salient content item UIEs 312 graphically display aspects of a corresponding salient content item from the subset 148. In particular, the “Monitor 1” UIE 312(1) previews what is currently being displayed on the user's first monitor, the “Browser 1” UIE 312(4) previews aspects of the competitor's website (which may be cached at the client computing device and/or may be dynamically retrieved the client computing device from the actual website), etc. In some implementations, the “preview” of content may triggered based on a hover state over the content items within the share-tray GUI 146. For example, upon the user holding the mouse curser over a particular content item for a predetermined amount of time, a rich preview of the content item may commence (e.g., a video may play w/o sound to “jog” the user's memory as to which files contain which content).

In some embodiments, the share-tray GUI 146 may be configured to display a predetermined number of the most salient content items from each category of content items having an assigned content type region 318. For instance, in the illustrated example, content type regions 318(2) through 318(5) each include only a single salient content item UIE 312 that corresponds to the most salient content item from that particular category, although, in other examples two or more UIEs can be included. In some embodiments, one or more of the content type regions 318 may include a content type expansion UIE 320 (labeled only in region 318(5)) that is selectable by the user to cause the share-tray GUI 146 to display additional salient content item UIEs for any particular category. In the scenario illustrated in FIG. 3B, the user is shown to be using a cursor to select a particular additional salient content item UIE 320 that correspond specifically to the Productivity Suite (PS) Tab region 318(2).

Turning now to FIG. 3C, aspects of the share-tray GUI 146 are shown with a particular content type region 318 in an expanded state. In particular, FIG. 3C shows an example implementation where the Productivity Suite (PS) Tab region 318(2) of FIG. 3B has been expanded to expose salient content item UIEs corresponding to a second-most salient productivity suite tab, a third-most salient productivity suite tab, and so on. As described elsewhere herein, the system 102 can determine the relative saliency between various content items based on a variety of factors to determine an ordered ranking of saliency between the content items as indicated by the saliency scale 322. Accordingly, it can be appreciated that the salient content item UIEs 312 that are displayed within the share-tray GUI 146 may be displayed according to a graphical arrangement that is based on saliency rankings of individual salient content items within the subset 148 as compared to other salient content items within the subset 148. In various implementations, the share-tray GUI 146 may further include one or more scroll UIEs 324 to enable the user to view additional salient content item UIEs 312 that are not currently displayed within the share-tray GUI 146. In the scenario illustrated in FIG. 3C, as indicated by the highlighting around the “Tab 1” UIE 312(3), the user has selected this particular UIE to send aspects of this content item to the stage of the conference session 104.

In some embodiments, the share-tray GUI 146 may include an indication of which content items have already been shared during the conference session. For example, “PS Tab 2: Action Items” is shown with a check symbol 325 that indicates to the user that this particular content item has already been shared during the current conference session. In some embodiments, the share-tray GUI 146 may include an indication of which content item is currently being shared. For example, upon a content item being sent to stage by the user, the share-tray GUI 146 may highlight or otherwise indicate to the user that that content item is being actively shared.

Turning now to FIG. 3D, aspects of the share-tray GUI 146 are shown in which salient content item UIEs 312 from a variety of categories are graphically arranged according to their relative saliency with respect to one another. In particular, in the example of FIG. 3D, the share-tray GUI 146 is configured to co-mingle salient content item UIEs 312 across one or more types and/or categories. For instance, as illustrated the share-tray GUI does not separate content item UIEs 312 into various separate content type regions 318.

In the scenario illustrated in FIG. 3D, the system 102 has determined a relative saliency between a plurality of content items of the subset 148 and is displaying corresponding UIEs 312 in a graphical arrangement as indicated by the saliency scale 322. In particular, as illustrated the share-tray GUI 146 renders the “Monitor 1” UIE 312(1) in a most prominent position based on a determination that the user is the most likely to elect to share content being rendered by the user's first monitor, the “Tab 1” UIE 312(3) in a second-most prominent position based on a determination that the next most likely content item the user will elect to share is the content associated with a “Team Performance” Productivity Suite (PS) Tab that has been associated with a Productivity Suite, etc.

Turning now to FIG. 3E, aspects of the share-tray GUI 146 are shown in an alternate graphical arrangement in which the salient content item UIEs 312 are separated according to types and/or categories and are further graphically arranged according to their relative saliency within their corresponding type and/or category. For example, similar to the version of the share-tray GUI 146 illustrated in FIG. 3B, the version of the share-tray GUI 146 shown in FIG. 3E also includes the salient screen region 318(1) that includes UIEs 312(1) and 312(2), the Productivity Suite (PS) Tab region 318(2) that includes the “Tab 1” UIE 312(3), the browser region 318(3) that includes a “Browser 1” UIE 312(4), and so on. However, in the scenario illustrated in FIG. 3E, the system 102 has determined relative saliencies between a plurality of content items within each category and has caused the share-tray GUI 146 to display one or more salient content type UIEs corresponding to each category in a graphical arrangement based on the relative saliencies. In particular, the displayed salient content item UIEs are arranged according to the saliency scale 322. In some implementations, the saliency scale 322 may be rendered in association with the share-tray GUI as shown in FIG. 3E. In other implementations, the displayed salient content item UIEs 312 may be arranged according to the saliency scale 322 without the saliency scale 322 being graphically rendered within the share-tray GUI 146.

In some implementations, the share-tray GUI 146 may be configured to occupy up to, but not more than, a predetermined portion of the persistent view 304. For example, in the illustrated scenario the share-tray GUI 146 is shown to occupy a portion of the persistent view 304 defined by a cutoff line 326 above which the share-tray GUI 146 does not extend even in the event that the subset 148 includes an amount of salient content items that is too great to be concurrently displayed within the predetermined portion of the persistent view 304. For example, in the illustrated scenario, the subset 148 of content items includes too many individual salient content items to be concurrently displayed within the data file region 318(4). Accordingly, the system 102 causes a scroll UIE 324 to be displayed in association with the data file region 318(4) to enable the user to manually scroll through salient content items within this category that are not currently displayed.

In one example, the system may be configured to perform a keyword comparison search of individual content items with respect to a meeting title of the conference session and to locate UIEs corresponding to the individual content items within the share-tray GUI based on the keyword comparison search. For example, as illustrated in FIG. 3E, the system may analyze session data associated with the conference session 104 wherein the session data indicates that the conference session is entitled “Product Design Team Meeting.” Then, the system may perform a keyword comparison search of a data file such as file one entitled “Product Review Slidedeck” to identify a similarity between the title of the meeting and content and/or a title of the particular file. As illustrated, the system has determined that file one entitled “Product Review Slidedeck” is the most salient data file with respect to the conference session and, therefore, has located the corresponding UIE within a most conspicuous position.

In some implementations, the share-tray GUI may include an “Apply Filter” UIE 328 to enable the user to define one or more share-tray population parameters 144. For instance, in the event that the share-tray GUI 146 does not immediately display a particular salient content item UIE that the user is looking for and for which the user remembers one or more specific attributes for, the user may define share-tray population parameters 144 corresponding to these attributes to cause the share-tray GUI 146 to render the particular salient content item UIE that the user is looking for. For example, upon selecting the “Apply Filter” UIE 328, aspects of the share-tray GUI 146 may be altered to enable the user to define the share-tray population parameters 144 directly within the share-tray GUI 146 that is being displayed during the conference session 104.

In some implementations, the share-tray GUI 146 may include an “Custom Trays” UIE 329 to enable the user to cause the share-tray GUI 146 to display UIEs corresponding to one or more user defined content items. For example, a user may define a “My Product Design” share-tray that includes a set of content items that the user frequently shares during design review meetings. Accordingly, the user may define aspects of the “My Product Design” share-tray prior to the conference session. Then, during the conferences session the user may open the “My Product Design” share-tray to be able to quickly share content items from the user defined set of content items. In some implementations, the user may pre-define and name a plurality of custom sets of content items and choose between these predefined sets while participating in a conference session. In some implementations, the user may set a default set of content items that is populated into the share-tray GUI 146 whenever the user joins a conference session.

Turning now to FIG. 3F, aspects of the share-tray GUI 146 are shown which enable the user to define one or more share-tray population parameters 144. In particular, in the illustrated scenario, the share-tray GUI 146 is shown to include a general search bar 330 that enables the user to define one or more share-tray population parameters 144 using a general search language that the system 102 is configured to utilize. For example, as illustrated, the user has input a search query using the phrase “TO: Invitees & WITHIN: 1 week” to cause the system 102 to identify content items that have been sent within the last 1 week by the user to any other user that is invited to the conference session 104. Additionally or alternatively, the share-tray GUI 146 may enable the user to define one or more share-tray population parameters 144 by selecting one or more predefined attribute types such as, for example, to whom particular content items have been sent, from whom particular content items have been received, a content type that particular content items can be categorized by, keywords that are present within particular content items, and any other suitable attribute that the system 102 can use to identify content items.

In the scenario illustrated in FIG. 3F, the user has defined share-tray population parameters 144 to cause the system 102 to identify and return POWERPOINT presentations that have been sent by the user to “Bob” and that contain the keyword “Stereo.” Upon receiving the user defined share-tray population parameters 144, the system 102 may deploy the share-tray population module 140 to analyze the content item data 214 and/or the activity log data 142 to identify content items having attributes that correspond to these parameters. Ultimately, one or more salient content item UIEs 312 that correspond to individual content items having the user-defined attributes may be displayed in a results region of the share-tray GUI 146. As illustrated, the system 102 has identified five content items satisfying the user-defined attributes and is displaying corresponding salient content item UIEs. As further illustrated, the user has selected a particular content item entitled “Competitor's New Speakers” and is provisioned with a variety of options on what the system can do with the selected content item.

In some implementations, the share-tray GUI 146 may enable the user to send the selected content item to one or more specific participants of the conference session 104. For example, the user may be inclined to share the selected content item with one specific participants of the conference session 104 to facilitate a “sidebar” discussion without unnecessarily disrupting the flow of the conference session 104 as a whole.

In some implementations, the share-tray GUI 146 may enable the user to seamlessly open the selected content item on a particular monitor at the user's client computing device. For example, the system 102 may recognize that the conference session 104 is being rendered on the user's second monitor and, therefore, may provide the user with the option to open the selected content item on the first monitor to situate the content item as desired prior to sharing the user's first monitor with the conference session 104. It can be appreciated that such a feature may be beneficial if the user wishes to review the selected content prior to sharing the content during the conference session (e.g., the user can jog the user's memory of the presentation's contents prior to the user's turn to speak).

In some implementations, the share-tray GUI 146 may enable the user to send the selected content item directly to the stage of the conference session 104 to thereby cause aspects of the content item to be rendered within the persistent view 304 on the client devices of the other participants.

In some implementations, the share-tray GUI 146 may be populated with content that is discovered within a “Content Bin” such as a clip-board or pasting area of the client computing device's memory. For example, prior to the conference session the user may take a clipping of an online news article that is relevant to the conference session. Then, during the conference session, this clipping may be recognized as salient to the conference session (e.g., based on keyword searching, when the clipping was taken, etc.) and displayed to the user to enable the user to share it with the other participants of the conference session.

Turning now to FIG. 3G, aspects of the share-tray GUI 146 are shown in an alternate arrangement in which one or more groupings of salient content items are shown in a list view arrangement having multiple columns of salient content item UIEs 312. In the illustrated scenario, the salience subset 148 of content items includes more than twenty-five salient data files and the share-tray GUI 146 is shown to render individual content item UIEs 312 for each of the first twenty-five salient data files as well as a scroll UIE 324 to enable the user to scroll through the additional salient data files if a desired data file is not initially rendered.

In some implementations, various content type regions 318 may be displayed differently according to system and/or user preferences. For example, in the illustrated scenario, the salient screen region 318(1) is shown to display relatively large preview thumbnails of each of the users monitors whereas the other content type regions (e.g., 318(3) and 318(4)) display content items in a more compacted arrangement to enable the user to view a larger number of content items within one or more of these other content type regions.

In various implementations, the share-tray GUI 146 may also include a tool tray to enable the user to utilize one or more of a “pointer” tool to point to portions of a shared content item, a “pen” tool to write directly over a portion of a shared content item, and/or a “type” tool to enable the user to type directly over (e.g., tag notes to) portions of a shared content item.

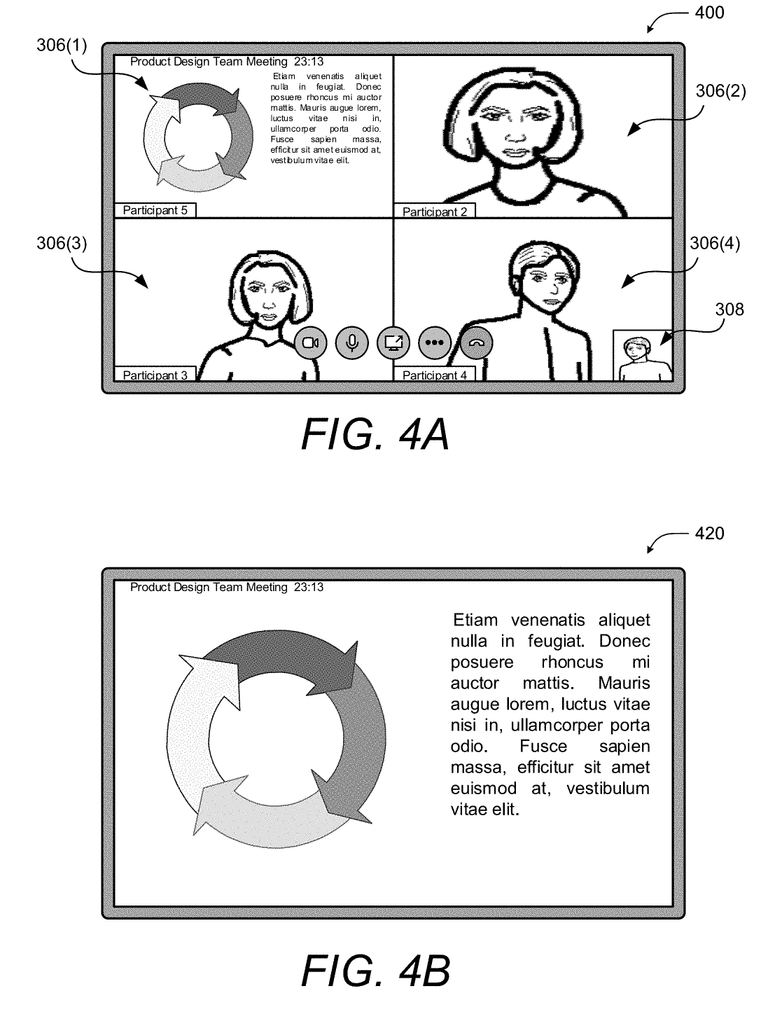

Turning now to FIG. 4A, aspects are illustrated of a “Partial-Stage” view GUI 400 that can be displayed on a client computing device corresponding to the first participant of the conference session in response to the user selecting the “Monitor 1” UIE 312(1) to share content that is currently being displayed on the first monitor of the user's client computing device 106. As illustrated, the Partial-Stage” view GUI 400 that is shown to the first participant includes a persistent view 304 that is split into regions 306(1) through 306(4). Here, because the user of the client computing device 106(1) has begun to actively share content, the user has been promoted to the first region 306(1) that corresponds to the most-dominant participant of the conference session 104.

FIG. 4B illustrates aspects of a “Full-Stage” view GUI 420 that can be displayed on the client computing device corresponding to the first participant in response to the user selecting the “Monitor 1” UIE 312(1) to share content that is currently being displayed on the first monitor of the user's client computing device 106. In various implementations, whether the first participant's client computing device displays the “Partial-Stage” view GUI 400 or the “Full-Stage” view GUI 420 may depend on user preferences set by the first participant. For example, due to having a sufficiently large display, the first participant may elect for the “Partial-Stage” view GUI 400 to both see and interact with other participants of the conference session 104 while simultaneously paying attention to the content being shared by the user.

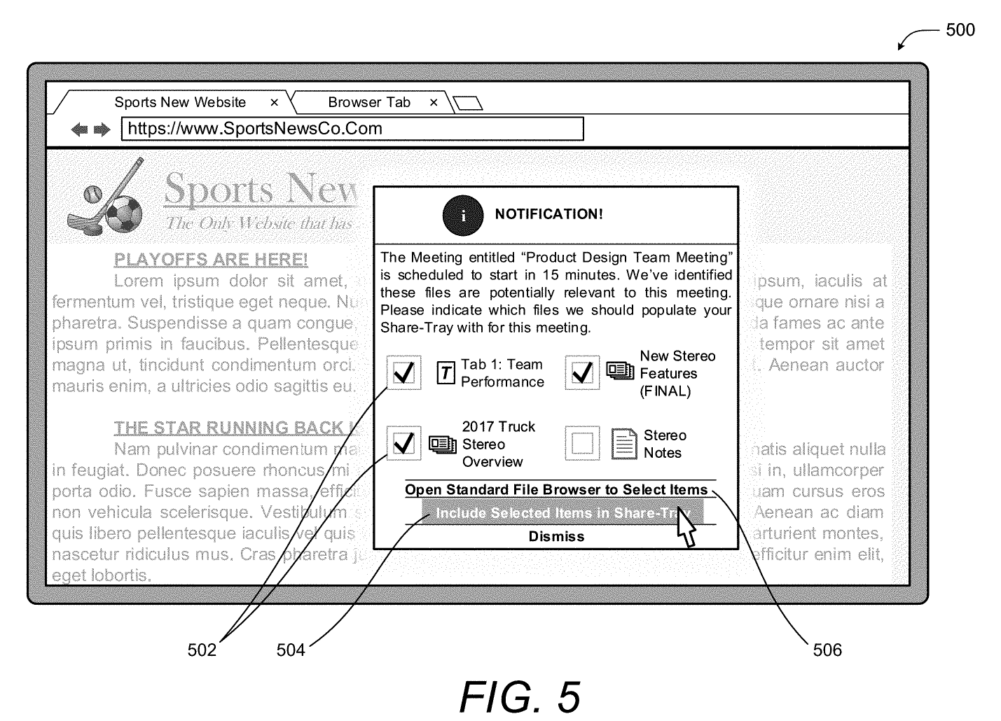

Turning now to FIG. 5, aspects are illustrated of a share-tray population GUI 500 that can be displayed on a client device 106 to enable a user to manually define one or more salient content items to be included within the share-tray GUI 146. As illustrated, the share-tray population GUI 500 is informing the user that a particular conference session entitled “Product Design Team Meeting” is scheduled to start in 15 minutes and also that the system 102 has identified one or more content items as being potentially relevant (e.g., salient) to the upcoming conference session. In various implementations, the share-tray population GUI 500 may include one or more item selection UIEs 502 that enable a user to select one or more of the content items that are suggested within the share-tray population GUI 500 for inclusion within the share-tray GUI 146. In the illustrated example, the user has selected three of the four salient content items suggested by the system 102 within the share-tray population GUI 500. As further illustrated, the user is using a cursor to select an “Include Selected” UIE 504 to instruct the system 102 to include the selected items within the share-tray GUI 146 upon the user joining the upcoming conference session.

In various implementations, the share-tray population GUI 500 (or features thereof) may be displayed to the user within a share-tray GUI 146 during a particular conference session to enable the user to control which items are being displayed within the share-tray GUI 146 “on-the-fly” during a particular conference session. For example, a user may know that he or she is going to be responsible to lead a portion of the conference session that is going to begin at some point in the future. To prepare for this portion of the conference session, the user may customize which salient content items are displayed within the share-tray GUI 146 while one or more other participants are leading their respective portion of the conference session. Accordingly, content items that the user is confident will not be shared during the user's portion can be removed from the share-tray GUI 146 to remove the appearance of clutter. Additionally or alternatively, content items that are not currently displayed within the share-tray GUI 146 may be manually added to the share-tray GUI 146 so that they can be quickly accessed and shared while the user is leading a portion of the conference session.

In various implementations, the share-tray population GUI 500 may further include a manual item selection UIE 506 that enables the user to manually select content items for inclusion within the share-tray GUI 146 through a standard file browser (e.g., a file browser that is configured to navigate through a directory structure of an operating system on the client computing device). For example, upon selection of the manual item selection UIE 506, the user may be provided with a user interface that enables the user to manually navigate through folders that are stored either locally at the user's client computing device and/or within one or more cloud storage services that are operatively connected to the client computing device. Thus, the user is enabled to navigate to one or more folders at which he or she has previously stored one or more content items that will be shared during the conference session.

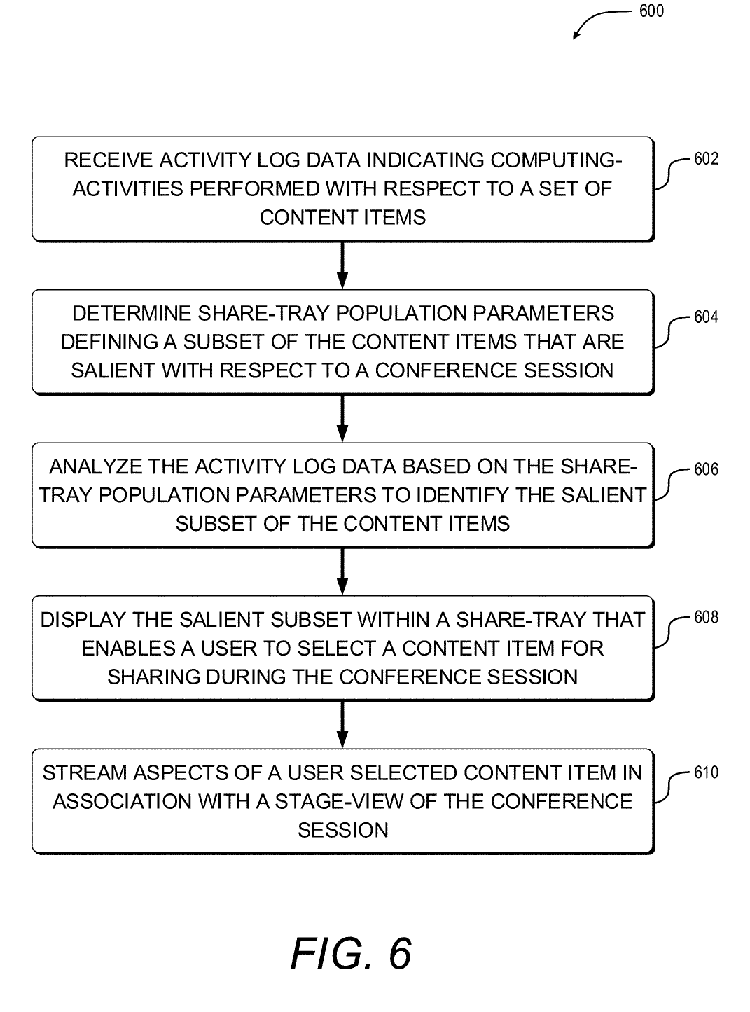

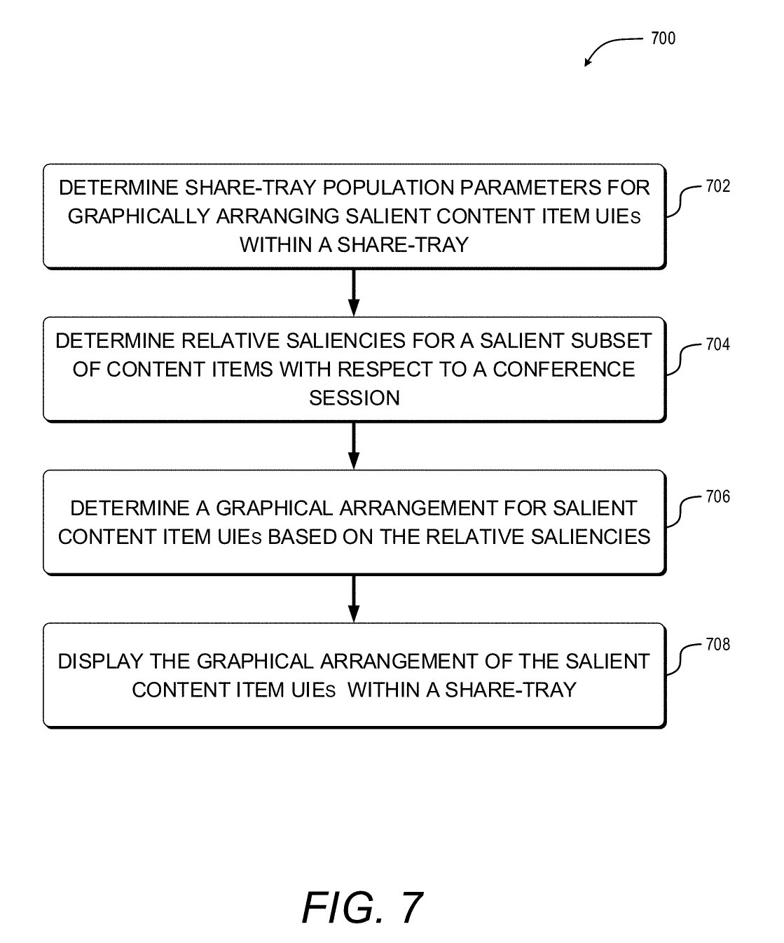

FIGS. 6 and 7 illustrate example flowcharts. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It also should be understood that the illustrated methods can end at any time and need not be performed in their entirety. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system (e.g., device 110, client computing device 106(N), and/or device 200) and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof.

Additionally, the operations illustrated in FIGS. 6 and/or 7 can be implemented in association with the example graphical user interfaces described above with respect to FIGS. 3A-5. For instance, the various device(s) and/or module(s) in FIGS. 1 and/or 2 can generate, transmit, receive, and/or display data associated with content of a conference session (e.g., live content, recorded content, etc.) and/or a share-tray GUI that includes salient content item UIEs corresponding to at least some content items of a salient subset.

FIG. 6 is a diagram of an example flowchart 600 that illustrates operations directed to identifying a salient subset of content items to populate into a share-tray GUI in association with a conference session. In one example, the operations of FIG. 6 can be performed by components of the system 102 and/or a client computing device 106.

At operation 602, activity log data may be received that indicates computing activities that have been performed with respect to a set of content items. In some instances, the activity log data may correspond to computing activities that have been performed locally at a user's client computing device. For example, the activity log data may be generated by an operating system of the client computing device to create a record of one or more properties associated with a data file such as a date that a data file was created, a date that a data file was last modified, a date that a data file was last accessed, and/or a frequency that modifications to a data file are saved during a particular time period leading up to a conference session. In some instances, the activity log data may correspond to computing activities performed by the user in association with a productivity suite and/or associated cloud computing services. For example, the activity log data may be generated by the productivity suite and/or cloud computing service to create a record of one or more computing instructions received from the client computing device such as instruction to transmit a data file to a particular user via an email message and/or an instant message, an instruction to upload a data file and/or content thereof into a cloud storage location, and/or an instruction to associated a data file with a calendar object corresponding to the conference session.

In some embodiments, the activity log data may indicate one or more activities that are performed by participants of the conference session other than the user. For example, the system 102 may identify that several other participants of the conference session have shared content items with participants other than the user during one or more previous conference sessions. Then, based on these activities, the system 102 may identify a particular content item to populate within the user's share tray GUI 146. Stated alternatively, the activity log data that the system 102 may analyze in order to identify content items for populating the share-tray GUI may include, but is not limited to, computing activities that are performed by the user.

At operation 604, share-tray population parameters may be determined that are usable to identify a subset of the content items that are salient with respect to a conference session. In various instances, the share-tray population parameters may define various content item attributes such as, for example, a temporal proximity to a conference session with which various computing activities take place, a keyword similarity of a content item with respect to one or more other content items associated with a conference session and/or a title of the conference session, an amount of collaborative computing activities that a user has performed with respect to a content item and one or more other users that are registered for the conference session (e.g., as identified through session data), and/or an amount of collaborative computing activities that a user has performed with respect to a content item and one or more invitees of the conference session as indicated by calendar data.

At operation 606, the activity log data may be analyzed based on the share-tray population parameters to identify a salient subset of the set of content items. For example, the activity log data may be analyzed to identify a subset of the content items that have been heavily modified and/or frequently saved during a threshold time period leading up to the conference session. Then, based on the temporal proximity to the conference session of these computing activities (e.g., the modifications and are frequent saving), this identified subset of the content items may be designated for inclusion within the salient subset. As another example, the activity log data may be analyzed to identify a subset of the content items that have been shared with a threshold number of participants of the conference session and/or invitees of the conference session via a communication channel such as, for example, an email channel and/or an instant messaging channel. Then, based on these particular content items being the subject of one or more collaborative computing activities (e.g. being emailed and/or instant message, being saved to a shared location, etc.), this identified subset of the content items may be designated for inclusion within the salient subset.

As used herein, a “set” of content items refers generally to any well-defined collection of content items. For example, a set of content items may include a single identified content item or multiple identified content items. As used herein, a “subset” of content items refers generally to any well-defined collection of content items wherein each content item of the “subset” is also included within a corresponding “set.” For example, if a first set of content items includes content items “A” through “D,” then a second set of content items that includes only content items “A” and “C” is a subset of the first set. Additionally, a third set of content items that includes only content items “A” through “D” is also a subset of the first set. Accordingly, it can be appreciated that a “salient subset” of content items may be a complete set of the “set” of content items.

At operation 608, the salient subset of content items may be displayed within a share-tray GUI during the conference session. More specifically, salient content item UIEs may be displayed within the share-tray GUI to enable the user to select one or more specific content items from the salient subset of content items and, ultimately, to share these specific content items with other participants of the conference session. For example, the user may select a specific content item for sharing during the conference session.

In various implementations, the share-tray GUI may be populated with UIEs that correspond to salient content items that are not currently active with respect to an operating system of a corresponding client computing device. For example, a particular salient content item may be a data file (e.g., a slide-based presentation, or a word processing document, etc.) that the user does not have open on the user's client computing device. Accordingly, the client computing device may populate the share-tray GUI with a salient content item UIE for a particular salient content item that is inactive with respect to (e.g., not open on) the client computing device. In some instances, the client computing device may be configured to open a local instance of the particular salient content item when the user selects the particular salient content item UIE.

At operation 610, aspects of the user selected content item may be streamed in association with a stage view of the conference session. For example, aspects of the selected content item may be displayed on a plurality of client computing devices associated with a plurality of other participants of the conference session. In some instances, the user is enabled to manipulate the aspects of the selected content item during the conference session while the manipulations are represented in substantially real time on the plurality of other client computing devices.

In some instances, when a user shares content during a conference session other users may be provided with a control request user interface element that enables them to request, from the user, control of the shared content during the conference session. For example, upon the user sharing a particular content item in association with a media stream, other participants' client computing devices may display a control request user interface element that one or more other participants may select to request, from the user, control over the particular content item that the user is sharing. Then, when another participant requests the control, client computing device of the user may render a control permission user interface element to enable the user to selectively grant or deny the other participant's request. In some implementations, the share-tray may render a “give control” UIE to enable the user to give control over a shared content item to another participant without that participant having to explicitly request control over the content item. For example, upon sharing a content item the system may render the “give control” UIE in association with a “drop-down” menu from which the user may select between the active participants of the conference session to pass control of the shared content item to.

FIG. 7 is a diagram of an example flowchart 700 that illustrates operations directed to arranging salient content item UIEs within a share-tray GUI based on their relative saliencies. In one example, the operations of FIG. 7 can be performed by components of the system 102 and/or a client computing device 106.

At operation 702, share-tray population parameters may be determined for graphically arranging salient content item user interface elements (UIEs) within a share-tray GUI in association with a conference session. For example, the share-tray population parameters may indicate where within the share-tray GUI highly salient content item UIEs should be graphically rendered with respect to less salient content item UIEs. As a more specific but nonlimiting example, FIGS. 3C-3E provide examples of graphical arrangements, of salient content item UIEs, that are determined based on the relative saliencies between individual ones of the salient content items.

At operation 704, relative saliencies may be determined for a salient subset of content items with respect to a conference session. For example, it may be determined that a first content item of the salient subset is the most salient with respect to the conference session, a second content item of the salient subset is the second most salient with respect to the conference session, and so on.

At operation 706, a graphical arrangement for the salient content item UIEs may be determined based on the relative saliencies determined at operation 704. An exemplary graphical arrangement may locate highly salient content items within highly conspicuous (e.g., visually prominent) positions within the share-tray GUI while locating less salient content items within less conspicuous positions. In some implementations, the less salient content items may be omitted from an initial state of the share-tray GUI such that an order for the user to see salient content item UIEs corresponding to the less salient content items, the user may need to use a scrollbar UIE to dynamically change which content item UIEs are currently displayed within the share-tray GUI.

Operation 708, the graphical arrangement of the salient content item UIEs that is determined at operation 706 be displayed to the user in association with the conference session. In particular, the share-tray GUI described herein may be displayed over a persistent view of the conference session at a client computing device wherein the graphical arrangement of the salient content item UIEs is displayed within the share-tray GUI to enable the user to select and ultimately share content items.

### EXAMPLE CLAUSES

The disclosure presented herein may be considered in view of the following clauses.

Example Clause A, a system comprising: one or more processing units; and a computer-readable medium having encoded thereon computer-executable instructions to cause the one or more processing units to: receive activity log data indicating at least one computing activity that a user has performed with respect to a set of content items; determine share-tray population parameters configured to define a subset of the set of content items to populate a share-tray graphical user interface (GUI), the subset of the content items configured to be streamed in association with a conference session; analyze the activity log data based on the share-tray population parameters to designate an individual content item, of the set of the content items, for inclusion in the subset; cause a first client computing device, that is associated with the user, to render the share-tray GUI in association with the conference session, wherein the share-tray GUI includes a user interface element (UIE) that enables a user selection of the individual content item from the subset; and based on the user selection, associate the individual content item with a media stream that enables at least one second client computing device to render aspects of the individual content item within a stage-view GUI that corresponds to the conference session.

Example Clause B, the system of Example Clause A, wherein the individual content item is designated for inclusion in the subset based at least in part on a temporal proximity, to the conference session, of the user performing the at least one computing activity with respect to the individual content item.

Example Clause C, the system of any one of Example Clauses A through B, wherein the computer-executable instructions further cause the one or more processing units to: receive session data associated with the conference session to identify a plurality of registered users that are registered with respect to the conference session; and analyze the activity log data to identify a collaborative computing activity that the user has performed with respect to a particular registered user of the plurality of registered users, wherein the individual content item is designated for inclusion in the subset further based on the collaborative computing activity.

Example Clause D, the system of any one of Example Clauses A through C, wherein the computer-executable instructions further cause the one or more processing units to: receive calendar data associated with the conference session to identify a plurality of invitees of the conference session; and analyze the activity log data to identify a collaborative computing activity that the user has performed with respect to a particular invitee of the plurality of invitees, wherein the individual content item is designated for inclusion in the subset further based on the collaborative computing activity.

Example Clause E, the system of any one of Example Clauses A through D, wherein the computer-executable instructions further cause the one or more processing units to cause the first client computing device to render a share-tray population GUI to enable the user to define, prior to the conference session, at least some of the share-tray population parameters.

Example Clause F, the system of any one of Example Clauses A through E, wherein the subset corresponds to a plurality of active content items that are being actively run by an operating system of the first client computing device.

Example Clause G, the system of any one of Example Clauses A through F, wherein the computer-executable instructions further cause the one or more processing units to: determine saliency rankings of a plurality of individual content items within the subset with respect to a plurality of other individual content items within the subset; and cause the first client computing device to render a plurality of UIEs that correspond to the plurality of individual content items in a graphical arrangement that is based on the saliency rankings.

Example Clause H, the system of any one of Example Clauses A through G, wherein the computer-executable instructions further cause the one or more processing units to perform a keyword comparison search of the set of the content items with respect to session data that is generated prior to commencement of the conference session, wherein the individual content item is designated for inclusion in the subset based at least in part on the keyword comparison search.

Example Clause I, the system of any one of Example Clauses A through H, wherein the set of content items includes at least one of data files, data folders associated with a directory structure of an operating system, computing applications, or user desktops.

While Example Clauses A through I are described above with respect to a system, it is understood in the context of this document that the subject matter of Example Clauses A through I can also be implemented by a device, via a computer-implemented method, and/or via computer-readable storage media.

Example Clause J, a computer-implemented method, comprising: receiving collaboration activity data indicating a plurality of collaborative computing activities that a user has performed with respect to a set of content items in association with at least one other user; determine share-tray population parameters configured to define a subset of the set of content items to populate a share-tray graphical user interface (GUI); analyzing the collaboration activity data based on the share-tray population parameters to determine a saliency of an individual content item, of the set of the content items, with respect to a conference session, wherein the individual content item is designated for inclusion in the subset based on the saliency of the individual content item with respect to the conference session; causing a first client computing device, that is associated with the user, to populate the share-tray GUI with a user interface element (UIE) that enables a user selection of the individual content item from the subset; and based on the user selection, associating the individual content item with a media stream that enables at least one second client computing device to render aspects of the individual content item within a stage-view GUI that corresponds to the conference session.

Example Clause K, the computer-implemented method of Example Clause J, wherein the first client computing device populates the share-tray GUI with the UIE, that enables the user selection of the individual content item, while the individual content item is inactive with respect to the first client computing device.

Example Clause L, the computer-implemented method of any one of Example Clauses J through K, wherein the plurality of collaborative computing activities that the user has performed include at least one of: saving the individual content item to a share location that is accessible by the at least one other user through a communication forum; transmitting the individual content item to the at least one other user via the communication forum; sharing the individual content item within a previous conference session that was facilitated through the communication forum; or adding data content that was received, via the communication forum, from the at least one other user into the individual content item.

Example Clause M, the computer-implemented method of any one of Example Clauses J through L, further comprising: receiving calendar data associated with the conference session to identify at least one invitee of the conference session; and analyzing the collaboration activity data with respect to the calendar data to designate as salient a particular set of the content items that the user has performed at least some of the plurality of collaborative computing activities with respect to the at least one invitee.

Example Clause N, the computer-implemented method of any one of Example Clauses J through M, further comprising: receiving user selection data indicating a second user selection of a share-tray expansion UIE that is rendered in association with the conference session; and causing the first client computing device to render the share-tray GUI in response to the second user selection.

Example Clause O, the computer-implemented method of any one of Example Clauses J through N, wherein the collaboration activity data corresponds to a team-based communication forum with which the user and the at least one other user are commonly associated.

While Example Clauses J through O are described above with respect to a method, it is understood in the context of this document that the subject matter of Example Clauses J through 0 can also be implemented by a device, by a system, and/or via computer-readable storage media.

Example Clause P, a system comprising: one or more processing units; and a computer-readable medium having encoded thereon computer-executable instructions to cause the one or more processing units to: determine share-tray population parameters for graphically arranging, within a share-tray graphical user interface (GUI), a plurality of user interface elements (UIEs) that are associated with a plurality of content items; determine, for individual content items of the plurality of content items, relative saliencies with respect to a conference session; determine, based on the share-tray population parameters, a graphical arrangement of the plurality of UIEs that corresponds to the relative saliencies of the individual content items; cause a client computing device to render the graphical arrangement of the plurality of UIEs within the share-tray GUI in association with the conference session, wherein individual UIEs, of the plurality of UIEs, enable a user selection of a particular content item from the plurality of content items; and based on the user selection, associate the particular content item with a media stream to cause at least one second client computing device to render aspects of the particular content item within a stage-view GUI that corresponds to the conference session.

Example Clause Q, the system of Example Clause P, wherein the computer-executable instructions further cause the one or more processing units to perform a keyword comparison search of the particular content item with respect to a meeting title of the conference session, wherein the particular content item is displayed within the share-tray GUI based at least in part on the keyword comparison search.

Example Clause R, the system of any one of Example Clauses P through Q, wherein the plurality of content items includes at least a first set of content items corresponding to a first content type and a second set of content items corresponding to a second content type, and wherein the share tray GUI includes a first content type region corresponding to the first content type and a second content type region corresponding to the second content type.

Example Clause S, the system of any one of Example Clauses P through R, wherein the computer-executable instructions further cause the one or more processing units to cause the client computing device to render at least one filter user interface element to enable the user to dynamically modify the share tray population parameters during the conference session.

Example Clause T, the system of any one of Example Clauses P through S, wherein the computer-executable instructions further cause the one or more processing units to: based on the user selection, cause the at least one second client computing device to render a control request UIE to enable a request to control the particular content item that is associated with the media stream to be generated at that at least one second client computing device; and based on the request, cause the first client computing device to render a control permission UIE that, upon selection, enables the aspect of the particular content item to be manipulated within the stage-view GUI via the at least one second client computing device.

While Example Clauses P through T are described above with respect to a system, it is understood in the context of this document that the subject matter of Example Clauses P through T can also be implemented by a device, via a computer-implemented method, and/or via computer-readable storage media.

Although the techniques have been described in language specific to structural features and/or methodological acts, it is to be understood that the appended claims are not necessarily limited to the features or acts described. Rather, the features and acts are described as example implementations of such techniques.

The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as FPGAs, DSPs, or other types of accelerators.

All of the methods and processes described above may be embodied in, and fully automated via, software code modules executed by one or more general purpose computers or processors. The code modules may be stored in any type of computer-readable storage medium or other computer storage device. Some or all of the methods may alternatively be embodied in specialized computer hardware.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art. It should be emphasized that many variations and modifications may be made to the above-described examples, the elements of which are to be understood as being among other acceptable examples. All such modifications and variations are intended to be included herein within the scope of this disclosure and protected by the following claims.

What is claimed is:

1. A system, comprising:
one or more processing units; and
a computer-readable medium having encoded thereon computer-executable instructions to cause the one or more processing units to:
receive activity log data indicating at least one computing activity that a user has performed with respect to a set of content items;
determine share-tray population parameters configured to define a subset of the set of content items to populate a share-tray graphical user interface (GUI), the subset of the content items configured to be streamed in association with a conference session;
analyze the activity log data based on the share-tray population parameters to designate an individual content item, of the set of the content items, for inclusion in the subset;
cause a first client computing device, that is associated with the user, to render the share-tray GUI in association with the conference session, wherein the share-tray GUI includes a user interface element (UIE) that enables a user selection of the individual content item from the subset; and
based on the user selection, associate the individual content item with a media stream that enables at least one second client computing device to render aspects of the individual content item within a stage-view GUI that corresponds to the conference session.

2. The system of claim 1, wherein the individual content item is designated for inclusion in the subset based at least in part on a temporal proximity, to the conference session, of the user performing the at least one computing activity with respect to the individual content item.

3. The system of claim 1, wherein the computer-executable instructions further cause the one or more processing units to:
receive session data associated with the conference session to identify a plurality of registered users that are registered with respect to the conference session; and
analyze the activity log data to identify a collaborative computing activity that the user has performed with respect to a particular registered user of the plurality of registered users, wherein the individual content item is designated for inclusion in the subset further based on the collaborative computing activity.

4. The system of claim 1, wherein the computer-executable instructions further cause the one or more processing units to:
receive calendar data associated with the conference session to identify a plurality of invitees of the conference session; and
analyze the activity log data to identify a collaborative computing activity that the user has performed with respect to a particular invitee of the plurality of invitees, wherein the individual content item is designated for inclusion in the subset further based on the collaborative computing activity.

5. The system of claim 1, wherein the computer-executable instructions further cause the one or more processing units to cause the first client computing device to render a share-tray population GUI to enable the user to define, prior to the conference session, at least some of the share-tray population parameters.

6. The system of claim 1, wherein the subset corresponds to a plurality of active content items that are being actively run by an operating system of the first client computing device.

7. The system of claim 1, wherein the computer-executable instructions further cause the one or more processing units to:
determine saliency rankings of a plurality of individual content items within the subset with respect to a plurality of other individual content items within the subset; and
cause the first client computing device to render a plurality of UIEs that correspond to the plurality of individual content items in a graphical arrangement that is based on the saliency rankings.

8. The system of claim 1, wherein the computer-executable instructions further cause the one or more processing units to perform a keyword comparison search of the set of the content items with respect to session data that is generated prior to commencement of the conference session, wherein the individual content item is designated for inclusion in the subset based at least in part on the keyword comparison search.

9. The system of claim 1, wherein the set of content items includes at least one of data files, data folders associated with a directory structure of an operating system, computing applications, or user desktops.

10. A method, comprising:
receiving collaboration activity data indicating a plurality of collaborative computing activities that a user has performed with respect to a set of content items in association with at least one other user;
determine share-tray population parameters configured to define a subset of the set of content items to populate a share-tray graphical user interface (GUI);
analyzing the collaboration activity data based on the share-tray population parameters to determine a saliency of an individual content item, of the set of the content items, with respect to a conference session, wherein the individual content item is designated for inclusion in the subset based on the saliency of the individual content item with respect to the conference session;
causing a first client computing device, that is associated with the user, to populate the share-tray GUI with a user interface element (UIE) that enables a user selection of the individual content item from the subset; and
based on the user selection, associating the individual content item with a media stream that enables at least one second client computing device to render aspects of the individual content item within a stage-view GUI that corresponds to the conference session.

11. The method of 10, wherein the first client computing device populates the share-tray GUI with the UIE, that enables the user selection of the individual content item, while the individual content item is inactive with respect to the first client computing device.

12. The method of 10, wherein the plurality of collaborative computing activities that the user has performed include at least one of:
saving the individual content item to a share location that is accessible by the at least one other user through a communication forum;
transmitting the individual content item to the at least one other user via the communication forum;
sharing the individual content item within a previous conference session that was facilitated through the communication forum; or
adding data content that was received, via the communication forum, from the at least one other user into the individual content item.

13. The method of 12, further comprising:
receiving calendar data associated with the conference session to identify at least one invitee of the conference session; and
analyzing the collaboration activity data with respect to the calendar data to designate as salient a particular set of the content items that the user has performed at least some of the plurality of collaborative computing activities with respect to the at least one invitee.

14. The method of 10, further comprising:
receiving user selection data indicating a second user selection of a share-tray expansion UIE that is rendered in association with the conference session; and
causing the first client computing device to render the share-tray GUI in response to the second user selection.

15. The method of 10, wherein the collaboration activity data corresponds to a team-based communication forum with which the user and the at least one other user are commonly associated.

16. A system, comprising:
one or more processing units; and
a computer-readable medium having encoded thereon computer-executable instructions to cause the one or more processing units to:
determine share-tray population parameters for graphically arranging, within a share-tray graphical user interface (GUI), a plurality of user interface elements (UIEs) that are associated with a plurality of content items;
determine, for individual content items of the plurality of content items, relative saliencies with respect to a conference session;
determine, based on the share-tray population parameters, a graphical arrangement of the plurality of UIEs that corresponds to the relative saliencies of the individual content items;
cause a client computing device to render the graphical arrangement of the plurality of UIEs within the share-tray GUI in association with the conference session, wherein individual UIEs, of the plurality of UIEs, enable a user selection of a particular content item from the plurality of content items; and
based on the user selection, associate the particular content item with a media stream to cause at least one second client computing device to render aspects of the particular content item within a stage-view GUI that corresponds to the conference session.

17. The system of claim 16, wherein the computer-executable instructions further cause the one or more processing units to perform a keyword comparison search of the particular content item with respect to a meeting title of the conference session, wherein the particular content item is displayed within the share-tray GUI based at least in part on the keyword comparison search.

18. The system of claim 16, wherein the plurality of content items includes at least a first set of content items corresponding to a first content type and a second set of content items corresponding to a second content type, and wherein the share tray GUI includes a first content type region corresponding to the first content type and a second content type region corresponding to the second content type.

19. The system of claim 16, wherein the computer-executable instructions further cause the one or more processing units to cause the client computing device to render at least one filter user interface element to enable the user to dynamically modify the share tray population parameters during the conference session.

20. The system of claim 16, wherein the computer-executable instructions further cause the one or more processing units to:
based on the user selection, cause the at least one second client computing device to render a control request UIE to enable a request to control the particular content item that is associated with the media stream to be generated at that at least one second client computing device; and
based on the request, cause the first client computing device to render a control permission UIE that, upon selection, enables the aspect of the particular content item to be manipulated within the stage-view GUI via the at least one second client computing device.
